(19) United States
(12) Patent Application Publication
(10) Pub. No.: US 2024/0174777 A1
(43) Pub. Date: May 30, 2024

(54) POLYPROPYLENES FOR ADDITIVE MANUFACTURING

(71) Applicant: FINA TECHNOLOGY, INC., Houston, TX (US)

(72) Inventors: Michael MCLEOD, Houston, TX (US); Fengkui LI, Houston, TX (US); Adrienne MUSIC, Pasadena, TX (US); Ngoc NGUYEN, Houston, TX (US)

(21) Appl. No.: 18/521,767

(22) Filed: Nov. 28, 2023

Related U.S. Application Data
(60) Provisional application No. 63/428,515, filed on Nov. 29, 2022.

(51) Int. Cl. C08F 110/06; C08J 9/232

(52) U.S. Cl. CPC C08F 110/06; C08J 9/232; C08J 2323/12

(57) ABSTRACT

Disclosed are methods of additive manufacturing comprising polypropylene, and compositions created using the same.

### CROSS-REFERENCE

This application claims priority to U.S. Provisional Patent Application Ser. No. 63/428,515, filed Nov. 29, 2022 entitled “Polypropylenes for Additive Manufacturing”, the contents of which are incorporated by reference herein in their entirety.

### BACKGROUND

### A. Field

The invention generally concerns at least methods of additive manufacturing comprising polypropylene, and compositions comprising the same.

### B. Description of Related Art

Polypropylene has use in multiple industries. For example, polypropylene containing compositions are used in packaging for consumer products, plastic parts for various industries including electrical, equipment manufacturing and automotive industry, household appliances, special devices like living hinges, and textiles. In some applications such as food storage containers, cups, lids, etc., good clarity of the resulting article of manufacture made from the polypropylene is desired.

A typical process for making such articles of manufacture includes thermoforming an extruded polypropylene sheet within a tool to form a thermoformed article. Typically, after the thermoforming process, a portion(s) of the extruded sheet is removed from the tool to form a final product. Other portions, such as non-removed portions, can be recycled and extruded again to form additional extruded sheets so as to avoid waste. However, traditional methods such as these can result in excess waste (materials and/or energy), and/or require thermoforming casts. There exists a need for alternative manufacturing methods to produce products made of polypropylenes.

One such alternative manufacturing method comprises additive manufacturing (AM), which is also known as 3-D printing (these terms are utilized interchangeably herein). Benefits to additive manufacturing when compared to traditional means of manufacturing may include lower energy consumption, reduced waste, manufacturing agility, and/or better inventory management. However, polypropylenes have not yet been effectively employed in additive manufacturing processes.

Problems associated with utilizing additive manufacturing to produce polypropylene-based products can include insufficient weld line strength, weak mechanical properties, sagging, poor/textured surface properties, porosity, shrinkage, warping and/or debonding.

### SUMMARY

A discovery has been made that provides a solution to at least some of the aforementioned problems.

In some embodiments, provided herein is an additive manufactured article comprising one or more polypropylene (PP) with one or more of the following properties: a) a melting temperature≤135° C., measured according to ASTM D3418-15; b) an onset of melting temperature≤125° C., measured according to ASTM D3418-15; c) an onset of crystallization temperature≤105° C., measured according to ASTM D3418-15; d) crystallinity of ≤35%, measured according to ASTM D3418-15; e) an Avrami exponent≤2.10; f) an absolute value for crystallization activation energy≤550,000 J/mol, as determined from Avrami kinetics fits; and/or g) an absolute value for crystallization activation energy that is less than or equal to 80% of the absolute value for crystallization activation energy of an unnucleated Ziegler-Natta homopolymer polypropylene.

In some embodiments, an additive manufactured article comprises one or more PP with one or more of the following characteristics: a) a melting temperature≤130° C., measured according to ASTM D3418-15; b) an onset of melting temperature≤120° C., measured according to ASTM D3418-15; c) an onset of crystallization temperature≤100° C., measured according to ASTM D3418-15; d) crystallinity of ≤30%, measured according to ASTM D3418-15; e) an Avrami exponent≤2.05; f) an absolute value for crystallization activation energy≤500,000 J/mol, as determined from Avrami kinetics fits; and/or g) an absolute value for crystallization activation energy that is less than or equal to 75% of the absolute value for crystallization activation energy of an unnucleated Ziegler-Natta homopolymer polypropylene.

In some embodiments, an additive manufactured article comprises one or more PP with at least two of the following characteristics: a) a melting temperature≤135° C. or ≤130° C., measured according to ASTM D3418-15; b) an onset of melting temperature≤125° C. or ≤120 °C., measured according to ASTM D3418-15; c) an onset of crystallization temperature≤105° C. or ≤100° C., measured according to ASTM D3418-15; and/or d) crystallinity of ≤35% or ≤30%, measured according to ASTM D3418-15.

In some embodiments, an additive manufactured article comprises at least one polypropylene that is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.

In some embodiments, the at least one PP has an absolute value for crystallization activation energy, as determined by isothermal differential scanning calorimetry (DSC) testing according to ASTM D3418-15 combined with Avrami kinetics fits, that are between about 300,000 J/mol to about 500,000 J/mol. In some embodiments, the at least one PP has a crystallinity of 35% to 15% based on a theoretical heat of fusion (ΔH0m) for 100% crystallized polypropylene of 207 J/g. In some embodiments, the at least one PP has a sintering window of 30° C. or lower, as defined by onset melting and crystallization temperatures. In some embodiments, the at least one PP has a sintering window of 18° C. to 30° C. In some embodiments, the at least one PP has a density of 0.8 g/cc to 1 g/cc measured according to ASTM D1505-18, and/or melt flow rate (MFR) of 0.1 g/10 min to 100.0 g/10 min, measured according to ASTM D1238-20. In some embodiments, the at least one PP has a melt flow of 0.5 g/10 min to 30 g/min, measured according to ASTM D1238-20.

In some embodiments, disclosed herein are methods of making an additive manufactured article comprising melting and/or sintering a composition comprising the one or more PP. In some embodiments, the at least one polypropylene is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof. In some embodiments, the article is made by sintering the PP in particulate form having an average particle size of 1 μm to 500 μm. In some embodiments, the particulate has an average particle size of 15 μm to 100 μm. In some embodiments, the method comprises material extrusion, wherein the composition in a melted state is extruded through a nozzle and is deposited in layers. In some embodiments, the method comprises sintering particles of the composition in a particulate form in a powder bed sintering (PBS) process. In some embodiments, the PBS process uses a layer thickness of 10 μm to 200 μm and/or a part bed temperature of 20° C. to 100° C. In some embodiments, the PBS process uses a layer thickness of 30 μm to 150 μm.

Also disclosed herein are articles of manufacture comprising an additive manufactured article made with any of the methods described herein. In some embodiments, the article is an automobile part, building material part, insulation part, electric instrument part, furniture part, textile part, container part, home appliance part, medical part, prosthetic, filter media, and/or custom toy.

Also disclosed herein are compositions for additive manufacturing, wherein the composition comprises at least one polypropylene (PP), and is in contact with at least one component designed for use in a 3-D printer, wherein the PP comprises one or more of the following properties: a) a melting temperature≤135° C., measured according to ASTM D3418-15; b) an onset of melting temperature≤125° C., measured according to ASTM D3418-15; c) an onset of crystallization temperature≤105° C., measured according to ASTM D3418-15; d) crystallinity of ≤35%, measured according to ASTM D3418-15; e) an Avrami exponent≤2.10; f) an absolute value for crystallization activation energy≤550,000 J/mol, as determined from Avrami kinetics fits; and/or g) an absolute value for crystallization activation energy that is less than or equal to 80% of the absolute value for crystallization activation energy of an unnucleated Ziegler-Natta homopolymer polypropylene.

In some embodiments, a composition for additive manufacturing comprising at least one PP in contact with at least one component designed for use in a 3-D printer, comprises one or more PP with one or more of the following characteristics: a) a melting temperature≤130° C., measured according to ASTM D3418-15; b) an onset of melting temperature≤120° C., measured according to ASTM D3418-15; c) an onset of crystallization temperature≤100° C., measured according to ASTM D3418-15; g) crystallinity of ≤30%, measured according to ASTM D3418-15; d) an Avrami exponent≤2.05; e) an absolute value for crystallization activation energy≤500,000 J/mol, as determined from Avrami kinetics fits; and/or f) an absolute value for crystallization activation energy that is less than or equal to 75% of the absolute value for crystallization activation energy of an unnucleated Ziegler-Natta homopolymer polypropylene.

In some embodiments, a composition for additive manufacturing comprising at least one PP in contact with at least one component designed for use in a 3-D printer, comprises one or more PP with at least two of the following characteristics: a) a melting temperature≤135° C. or ≤130° C., measured according to ASTM D3418-15; b) an onset of melting temperature≤125° C. or ≤120° C., measured according to ASTM D3418-15; c) an onset of crystallization temperature≤105° C. or ≤100° C., measured according to ASTM D3418-15; and/or d) crystallinity of ≤35% or ≤30%, measured according to ASTM D3418-15.

In some embodiments, the at least one PP is a Ziegler-Natta based random copolymer, metallocene random copolymer, and/or syndiotactic PP, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof. In some embodiments, a composition for additive manufacturing comprises at least 95 wt. % of at least one PP. In some embodiments, the PP is in contact with a 0.4 mm extruder nozzle, a 0.35 mm extruder nozzle, a build plate, and/or a heated bed. In some embodiments, the PP has an absolute value for crystallization activation energy, as determined by isothermal differential scanning calorimetry (DSC) testing according to ASTM D3418-15 combined with Avrami kinetics fits, that are between about 300,000 J/mol to about 500,000 J/mol. In some embodiments, the PP has a crystallinity of 35% to 15% based on a theoretical heat of fusion (ΔH0m) for 100% crystallized polypropylene of 207 J/g. In some embodiments, the PP has a sintering window of 30° C. or lower, as defined by onset melting and crystallization temperatures. In some embodiments, the PP has a sintering window of 18° C. to 30° C. In some embodiments, the PP has a density of 0.8 g/cc to 1 g/cc measured according to ASTM D1505-18, and/or melt flow of 0.1 g/10 min to 100 g/10 min, measured according to ASTM D1238-20. In some embodiments, the PP has a melt flow of 0.5 g/10 min to 30 g/10 min. In some embodiments, the PP is in particulate form having an average particle size of 1 μm to 500 μm. In some embodiments, the particulate has an average particle size of 15 μm to 100 μm.

Other embodiments of the invention are discussed throughout this application. Any embodiment discussed with respect to one aspect of the invention may apply to other aspects of the invention as well and vice versa. Each embodiment described herein is understood to be embodiments of the invention that may be applicable to other aspects of the invention. It is contemplated that any embodiment or aspect discussed herein may be combined with other embodiments or aspects discussed herein and/or may be implemented with respect to any method or composition of the invention, and vice versa. Furthermore, compositions and systems of the invention may be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising.” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present inventions can “comprise,” “consist essentially of,” or “consist of” particular ingredients, components, compositions, steps, etc. disclosed throughout the specification. With respect to the transitional phrase “consisting essentially of,” in one non-limiting aspect, a basic and novel characteristic of the composition, and processes of the present inventions are compositions comprising and/or methods using one or more polypropylenes (PP) with one or more of the following properties, a) a melting temperature≤135° C., measured according to ASTM D3418-15; b) an onset of melting temperature≤125° C., measured according to ASTM D3418-15; c) an onset of crystallization temperature≤105° C., measured according to ASTM D3418-15; d) crystallinity of ≤35%, measured according to ASTM D3418-15; e) an Avrami exponent≤2.10; f) an absolute value for crystallization activation energy≤550,000 J/mol, as determined from Avrami kinetics fits; and/or g) an absolute value for crystallization activation energy that is less than or equal to 80% of the absolute value for crystallization activation energy of an unnucleated Ziegler-Natta homopolymer polypropylene.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIGS. 1 A-C (Prior Art)—Depicts schematics for exemplary additive manufacturing (AM) processes. (A) depicts a schematic for an exemplary fused deposition (FD) modelling process. (B) depicts a schematic of the interface healing at weld lines during an additive manufacturing process. (C) depicts a schematic of production creation and trouser tear testing on an AM created product.

FIG. 2 (Prior Art)—Depicts a schematic for an exemplary Selective Laser Sintering (SLS) process, also known as a Laser Beam Powder Bed Fusion (PBF-LB).

FIG. 3 (Prior Art)—Depicts a Differential Scanning calorimetry (DSC) thermogram indicating the “sintering window” of SLS-processing region between the melting temperature (Tm) and crystallization temperature (Tc). The sintering window is calculated as the ΔT of (Tm-Tc)onset.

FIGS. 4 A-E—Depicts (DSC) thermogram data which is depicted as the melting and crystallization traces for (A) Polypropylene (PP) 3270, (B) PP 3276, (C) PP Z9450, (D) PP M9675, and (E) PP 1251.

FIGS. 5 A-E—Depicts (DSC) thermogram data provided in FIGS. 4 A-E superimposed with the sintering window for the respective PP as defined by onset melting and onset crystallization temperatures. (A) depicts PP 3270, which displayed a sintering window of 158.72−117.88=40.84° C. (B) depicts PP 3276, which displayed a sintering window of 149.26−114.91=34.35° C. (C) depicts PP Z9450, which displayed a sintering window of 112.48−92.94=19.54° C. (D) depicts PP M9675, which displayed a sintering window of 115.44−89.92=25.52° C. (E) depicts PP 1251, which displayed a sintering window of 108.67−81.18=27.49° C.

FIG. 6—Depicts a graph showing the crystallization half-time (min.; Y-axis) compared to the temperature (° C.; X-axis) from isothermal DSC crystallization tests for PP 3270, PP 3276, PP Z9450, PP M9675, and PP 1251 respectively.

FIG. 7—Is a mapping of PP Avrami exponents versus temperature. The left panel depicts a graph showing the calculated Avrami exponent (Y axis) compared to the temperature (° C.; X-axis) for PP 3270, PP 3276, PP Z9450, PP M9675, and PP 1251 respectively. The right panel depicts the average Avrami Exponent for each of PP 3270 (2.21), PP 3276 (2.30), PP Z9450 (1.89), PP M9675 (2.20), and PP 1251 (1.98) respectively.

FIG. 8—Depicts a graph showing the Ln (ka) (Y-axis) compared to the 1/(RT) (X-axis) for each of PP 3270, PP 3276, PP Z9450, PP M9675, and PP 1251 respectively. A linear line of best fit and associated R² value for each PP were determined.

### DETAILED DESCRIPTION

A discovery has been made that provides a solution to at least some of the aforementioned problems associated with utilization of polypropylene for additive manufacturing. These and other non-limiting aspects of the present invention are discussed in further detail in the following sections.

### A. Additive Manufacturing

Additive manufacturing (AM) (also commonly called 3 dimensional (3-D) printing, which terms are utilized interchangeably herein) is a process of tailor-making articles by selective material deposition. From its 1980s origins with Charles Hull, his company (3D Systems), and Patent Application 4575330A (Apparatus for production of three-dimensional objects by stereolithographic), the industry has grown.

Within the last few decades, a number of major additive manufacturing methods have been developed. ISO/ASTM 59000 has defined seven process categories, these include: Binder Jetting (liquid bonding agent is deposited to join powders), Directed Energy Deposition (Thermal energy melts materials as deposited), Material Extrusion (materials are selectively dispensed from one or more nozzle(s) and/or orifices), Material Jetting (thermal energy selectively fuses powder bed regions), Sheet Lamination (material sheets are bonded), and Vat Polymerization (liquid photopolymer in a vat is selectively cured by light-activated polymerization).

There can be numerous benefits to additive manufacturing when compared to traditional means of manufacturing. In some embodiments, benefits of additive manufacturing comprise: lower energy consumption, reduced waste, reduced time to market, agility/innovative capacity, part consolidation, lighter weight materials, decentralized manufacturing, and/or improved inventory management. These and other features have generated broad interest in utilizing 3-D printing (also interchangeably referred to herein as “additive manufacturing”) for a wide range of applications, including but not limited to, medicine, life-sciences research and development, food preparation, organ replacement, medical prosthetics, furniture, consumer electronics, apparel, aerospace, power tools, retail hardware, residential and/or commercial building materials, guns, ammunition, military/defense, motor vehicles and/or motor vehicle parts, sports equipment, and consumer products (e.g., toys, craft/hobby materials, animation, gaming, etc.).

### 1. Fused Deposition Modeling (FDM)

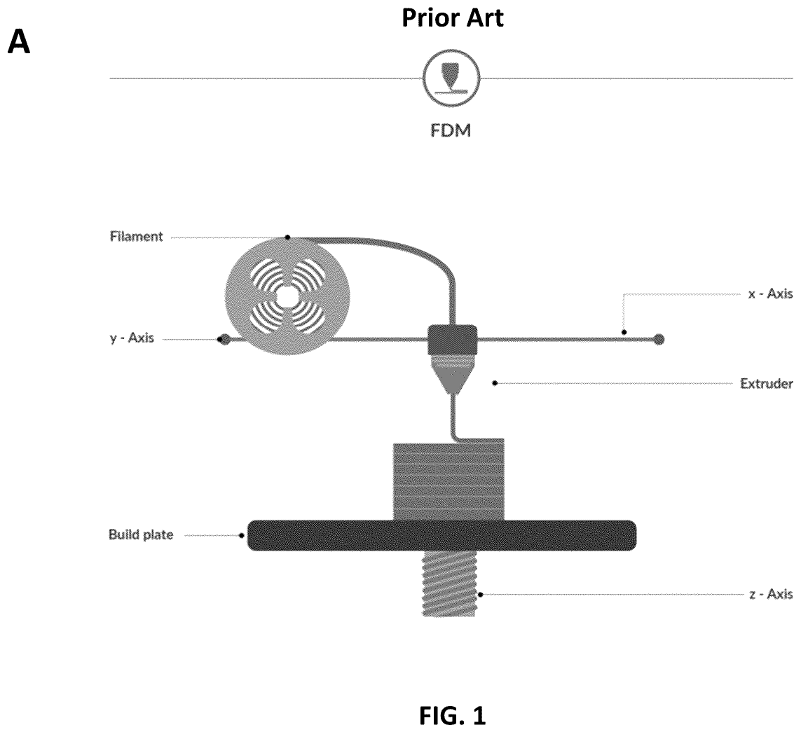

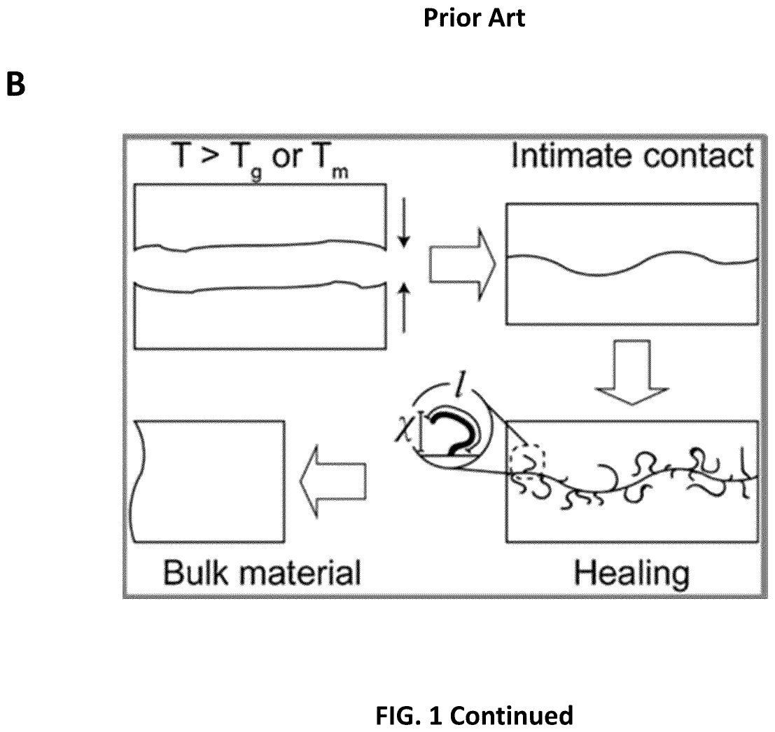

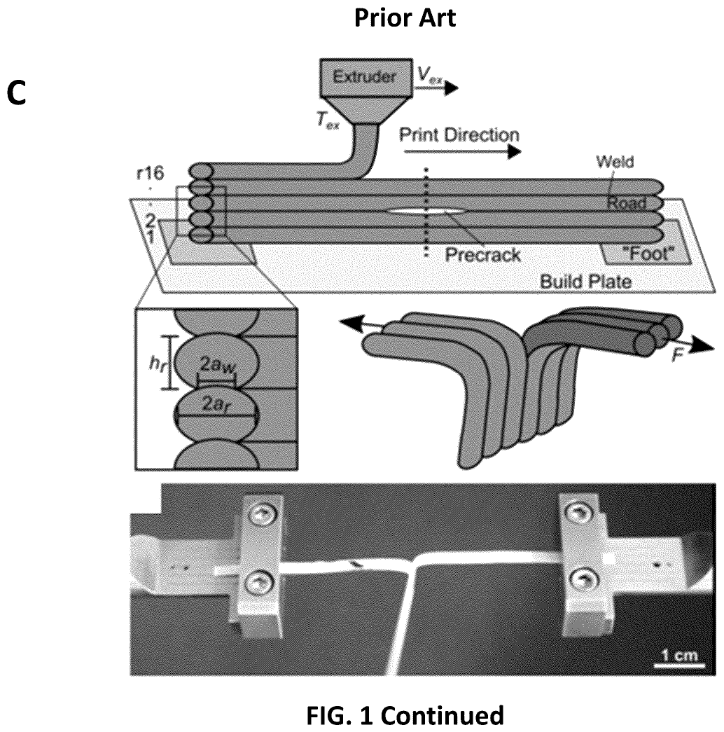

Fused Deposition Modeling (FDM) is an AM technique that has been reported to have the largest market share. As described in ISO/ASTM 59000, this is a Material Extrusion process type. Fused Deposition Modeling (FDM) can also be called Fused Filament Fabrication (FFF). In some embodiments, the process starts with a polymer monofilament. In some embodiments, a filament is heated in a die head assembly and extruded out of a nozzle as a polymer melt. In some embodiments, a melt is deposited one layer at a time to build a final part. In some embodiments, as each layer is built, a printer head indexes one layer height upwards before continuing to a next layer (alternatively the build plate indexes one layer height lower). The flexibility and low entry costs associated with the process have made FDM a popular approach for hobbyists up through high end manufacturing use. A schematic depicting an FDM process is provided in FIG. 1 A (sourced from Druckwege 3D printing).

An important attribute of FDM is that each successive layer needs to join with the prior layer. This involves the interface between two successive layers having enough molecular diffusion to knit together and form a strong weld line. This attribute is described schematically in FIG. 1 B (sourced from Fatemah Mashayekhi et al., Fused Filament Fabrication of Polymers and Continuous Fiber-Reinforced Polymer Composites: Advances in Structure Optimization and Health Monitoring. Polymers (Basel), Mar. 4, 2021). The weld lines between layers can in some instances be inherent potential weak points in FDM. For example, additive manufactured products can be ruined if voids are formed at this interface and/or if sufficient molecular diffusion does not occur. Davis and colleagues (Davis et al., Mechanical strength of welding zones produced by material extrusion additive manufacturing. Additive Manufacturing, Jun. 17, 2017) discuss weld line strength in acrylonitrile butadiene styrene (ABS) printed parts. Davis et al., illustrate the process, specimen creation and tensile testing of an additive manufactured article via a “trouser test” described schematically in FIG. 1 C. A trouser test conducted this way is a modified form of ASTM D1938-14 Mode III. Migler and colleagues describe the problems associated with weld line knitting as “a race against time” (see e.g., Migler et al., Presentation—Challenges in Additive Manufacturing of Soft Materials: Polymer-based Fused Deposition Modeling. Department of Physics, Institute for Soft matter Synthesis and Metrology, NIST Polymers and Complex Fluids Group).

Weld line strength can become more complicated in semicrystalline polymers (see e.g., Andrea Costanzo et al., Light scattering approach to the in situ measurement of polymer crystallization during 3D printing: A feasibility study. Polymer Crystallization. 2021; 4:e10182). In amorphous polymers, the inter-chain diffusion process is opposed by cooling and ceases when the glass transition temperature is reached. For semi-crystalline polymers, the welding efficiency is linked to the competing kinetics of chain diffusion (or “reptation” in deGennes parlance) versus the kinetics of crystallization. If the crystallization rate occurs too quickly, the polymer chains have insufficient time to diffuse and intertwine with each other to heal that weld line. This can result in a weak final additive manufactured product.

Beyond weak mechanical properties, other difficulties are recognized in FDM, as summarized by Migler and coworkers. For example, Polymer FDM can result in products with weak mechanical properties, sagging, poor/textured surface properties, porosity, shrinkage, warping, and/or debonding. The unique melt processing method, inherent in layer-by-layer part creation, imposes its own unique set of difficulties. Practitioners of the art are keenly interested in novel approaches and technologies that mitigate and/or overcome these problems

Semicrystalline polymers can amplify any one or more of these negative attributes when utilized in FDM. For instance, Fitzharris and colleagues (see e.g., Fitzharris et al., Effects of material properties on warpage in fused deposition modeling parts. International Journal of Advanced Manufacturing Technology. Nov. 18, 2017) state “Extending FDM technology to semicrystalline polymers has been challenging due to the crystallization that occurs during cooling which results in FDM part warpage.” Additionally, Spoerk, Holzer and Gonzalez-Gutierrez (see e.g., Spoerk et al., Material extrusion-based additive manufacturing of polypropylene: A review on how to improve dimensional inaccuracy and warpage. Journal of Applied Polymer Science. Oct. 15, 2019) highlight warpage as a key problem for polypropylene based FDM parts. Additionally, Spoerk et al., note that in PP there may be competing types of crystallinity being produced—where certain processing conditions favor more formation of β-crystals versus α-crystals, which, from a product quality and consistency viewpoint, creates another variable that must be regulated. Additionally, in Agbelenko Koffi's 2021 PhD dissertation, the current understanding in the field is summarized as follows, “basic semi-crystalline plastics, namely low-density polyethylene (LDPE), linear LDPE, high density polyethylene (HDPE), polypropylene etc. and certain types of polyamide are particularly difficult to treat with material extrusion-additive manufacturing (ME-AM); and although these materials have exceptional and unique properties, their application in ME-AM has not yet been deepened and studied in the literature.” (Agbelenko Koffi, Study of injection parameters of fiber composites natural and performance enhancement material mechanics for 3D printing. University of Quebec. February 2021).

At the same time, the field recognizes that semicrystalline polymers may provide certain advantages over amorphous thermoplastics that would be attractive in FDM-produced particles. For example, advantages may include, but are not limited to, higher ranges of continuous use temperature, the ability for use above the glass transition temperature, better resistance to creep deformation, and/or excellent chemical and wear resistance (sec e.g., Kishore et al., Additive manufacturing of high performance semicrystalline thermoplastics and their composites. Proceedings of the 27th Annual International Solid Freeform Fabrication Symposium. 2016). In certain scenarios, polypropylene in particular may be advantaged over other suitable materials. For example, in certain embodiments, polypropylene may be advantaged in terms of living hinge performance, weight (e.g., light weight), toughness, flexibility, chemical resistance, heat resistance (e.g., good stability in boiling water) and/or other properties (see e.g., Encyclopedia Britannica, definition of polypropylene chemical compound (Dec. 6, 2017); Engineering ToolBox, (2003). PP Polypropylene—Chemical Resistance; and/or Marline Steel, 7 Need-to-know polypropylene material properties (Jan. 16, 2020)).

There exists a need to overcome the challenges in FDM posed by use of semicrystalline polymers, particularly polypropylene, so that the benefits of these useful polymers can be more fully realized.

Described herein, among other things, are methods and compositions that have overcome any subset of these problems, for example, wherein additive manufactured products (e.g., compositions, articles, etc.) comprising polypropylenes with certain characteristics as disclosed herein (e.g., melting temperature, onset of melting temperature, onset of crystallization temperature, crystallinity, Avrami exponent value, absolute value for crystallization activation energy, and/or relative absolute value for crystallization activation energy) have improved properties when compared to conventional additive manufactured products. In certain embodiments, disclosed herein are additive manufactured compositions, and methods of making the same, with improved mechanical properties, improved rigidity, improved texture and/or other surface properties, reduced porosity, improved stability, improved resistance to warpage, improved tear strength resistance, and/or improved bonding strength. In certain embodiments, disclosed herein are additive manufactured compositions with improved rigidity (e.g., reduced levels of sagging). In certain embodiments, disclosed herein are additive manufactured compositions with improved texture and/or other surface properties. In certain embodiments, disclosed herein are additive manufactured compositions with reduced porosity. In certain embodiments, disclosed herein are additive manufactured compositions with improved stability (e.g., less shrinkage). In certain embodiments, disclosed herein are additive manufactured compositions with improved resistance to warpage. In certain embodiments, disclosed herein are additive manufactured compositions with improved tear strength resistance. In certain embodiments, disclosed herein are additive manufactured compositions with improved bonding strength.

### 2. Selective Laser Sintering (SLS)

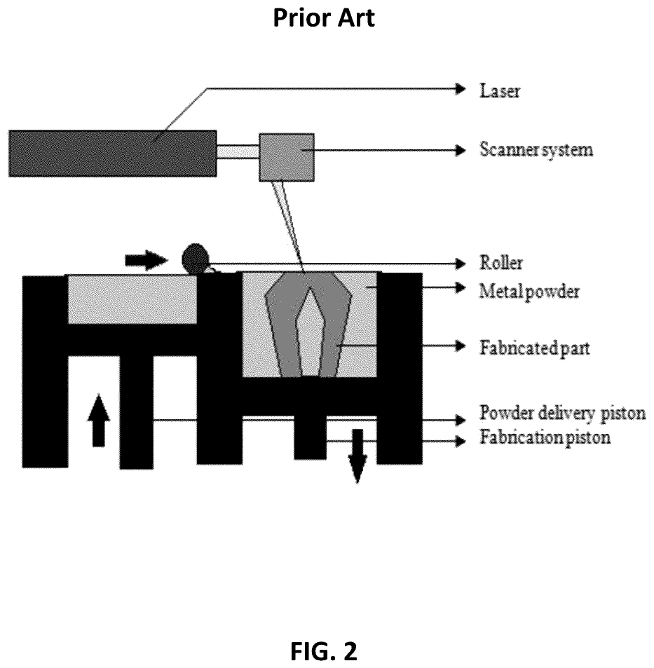

Another common additive manufacturing technique that utilizes polymers is Selective Laser Sintering (SLS), also known as Laser Beam Powder Bed Fusion (PBF-LB) or as a Powder Bed Sintering (PBS) process. A schematic representation of SLS is shown as FIG. 2 (modified from Alghamdi et al., Additive Manufacturing of Polymer Materials: Progress, Promise, and Challenges. Polymers (Basel), Feb. 28, 2021). SLS utilizes a polymer powder as the substrate component. Polymer powder substrate generally uses some level of particle size consistency to ensure best functional performance. Certain advantages associated with this technique can include low cost per part, high productivity, and/or excellent mechanical properties resembling those of injection-molded parts (see e.g., FormLabs, Guide to selective laser sintering (SLS) 3D printing. Formalbs.com (2022). In general, the polymer most commonly used with SLS is polyamide 12; which may represent ˜90% of the market share (see e.g., Schmid et al., Polymer powders for selective laser sintering (SLS). Conference: Proceedings of PPS-30: The 30th international conference of the polymer processing society—conference papers. May 22, 2015; and/or Mwania et al., Mixing and Reuse of Polymer Laser Sintering Powders to Ensure Homogeneity—A Review. International Journal of Engineering Research and Technology. 2020).

There are reasons to expand SLS additive manufacturing to other polymers other than predominantly polyamide 12, such as polypropylene. In certain embodiments, polypropylene provides an attractive alternative substrate to polyamide 12 (see e.g., Advanc3dMaterials AdSint PP flex polypropylene powder, which alleges a 29% elongation in SLS, and/or Advanced laser Materials (ALM) & Braskem's product, PP400 (2020), which alleges a 50% elongation of break, providing impact resistance in dynamic environments).

However, current methods of using polypropylene in SLS based additive manufacturing may result in products with one or more undesirable characteristics. For example, FormLabs acknowledges that 3D printed parts can have a slightly grainy surface finish, which in certain conditions, can be mitigated with post-manufacturing treatment of an article (see e.g., FormLabs, Guide to selective laser sintering (SLS) 3D printing. Formalbs.com (2022)). In some situations, powder substrate can present handling and housekeeping difficulties, and systems often require dust-tight and/or air-tight containers to prevent accidental spillage and/or leakage of what are often flammable substrates (see e.g., LyondellBasell, Handling and storage of polymers (document 9416/1204)). In some situations, static electricity can impede powder flow and distribution (see e.g., PowderProcess.net, Static electricity influence on powder flow (2022)). In some situations, powder morphology and particle size distribution have to be carefully controlled for production consistency (see e.g., Berretta et al., Size, shape and flow of powders for use in Selective Laser Sintering (SLS). University of Exeter Open Research. Jul. 18, 2014). In some situations, when utilizing polypropylene, particle size control can involve somewhat cumbersome steps of cryogenic grinding followed by dissolution-precipitation to effectively control particle size. In some situations, wavelength-dependent absorption properties of polymers, which constrain what polymers sinter well at typical wavelengths, can require the addition of absorbing additives.

There exists a need to overcome the challenges in SLS posed by use of semicrystalline polymers, particularly polypropylene, so that the benefits of these useful polymers can be more fully realized. Provided herein are descriptions, data, and examples, that among other things, elucidate what polypropylenes may be most suited for SLS based additive manufacturing.

### B. Polymeric Composition

In some embodiments, compositions of the present invention contain at least 90 wt. %, such as 90 wt. % to 99.9 wt. % or at least any one of, equal to any one of, or between any two of 90, 91, 92, 93, 94, 95, 96, 97, 98, 99, 99.1, 99.2, 99.3, 99.4, 99.5, 99.6, 99.7, 99.8, and 99.9 wt. % of polypropylene. In some aspects, the polymeric composition of the present invention can contain, at least 95 wt. %, such as 95 wt. % to 99.9 wt. %, or 96 wt. % to 99.9 wt. %, or 97 wt. % to 99.9 wt. %, or 98 wt. % to 99.9 wt. %, or 99 wt. % to 99.9 wt. %, of the polypropylene.

### 1. Polypropylenes and Properties Thereof

In certain embodiments, provided herein are polypropylenes with certain characteristics that enable their use as substrates in additive manufacturing processes.

In certain embodiments, a polypropylene has a melting temperature less than or equal to about 155, 154, 153, 152, 151, 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, or 100° C., or any range derivable therein, when measured according to ASTM D3418-15.

In certain embodiments, a polypropylene has an onset of melting temperature less than or equal to about 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, or 100° C., or any range derivable therein, when measured according to ASTM D3418-15.

In certain embodiments, a polypropylene has an onset of crystallization temperature less than or equal to about 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, or 70° C., or any range derivable therein, when measured according to ASTM D3418-15.

In certain embodiments, a polypropylene has a crystallinity of less than or equal to about 45, 44, 43, 42, 41, 40, 39, 38, 37, 36, 35, 34, 33, 32, 31, 30, 29, 28, 27, 26, 25, 24, 23, 22, 21, or 20% or any range derivable therein, when measured according to ASTM D3418-15.

In certain embodiments, a polypropylene has two or more of: a melting temperature less than or equal to about 155, 154, 153, 152, 151, 150, 149, 148, 147, 146, 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, or 100° C., or any range derivable therein, when measured according to ASTM D3418-15; an onset of melting temperature less than or equal to about 145, 144, 143, 142, 141, 140, 139, 138, 137, 136, 135, 134, 133, 132, 131, 130, 129, 128, 127, 126, 125, 124, 123, 122, 121, 120, 119, 118, 117, 116, 115, 114, 113, 112, 111, 110, 109, 108, 107, 106, 105, 104, 103, 102, 101, or 100° C., or any range derivable therein, when measured according to ASTM D3418-15; an onset of crystallization temperature less than or equal to about 115, 114, 113, 112, 111, 110, 109, 108, 107, 106, 105, 104, 103, 102, 101, 100, 99, 98, 97, 96, 95, 94, 93, 92, 91, 90, 89, 88, 87, 86, 85, 84, 83, 82, 81, 80, 79, 78, 77, 76, 75, 74, 73, 72, 71, or 70° C., or any range derivable therein, when measured according to ASTM D3418-15; and/or a crystallinity of less than or equal to about 45, 44, 43, 42, 41, 40, 39, 38, 37, 36, 35, 34, 33, 32, 31, 30, 29, 28, 27, 26, 25, 24, 23, 22, 21, or 20% or any range derivable therein, when measured according to ASTM D3418-15.

In certain embodiments, a polypropylene has an Avrami exponent less than or equal to about 2.20, 2.19, 2.18, 2.17, 2.16, 2.15, 2.14, 2.13, 2.12, 2.11, 2.10, 2.09, 2.08, 2.07, 2.06, 2.05, 2.04, 2.03, 2.02, 2.01, 2, 1.99, 1.98, 1.97, 1.96, 1.95, 1.94, 1.93, 1.92, 1.91, 1.90, 1.89, 1.88, 1.87, 1.86, 1.85, 1.84, 1.83, 1.82, 1.81, or 1.80, or any range derivable therein, when calculated as described herein (see e.g., Example 4).

In certain embodiments, a polypropylene has an absolute value for crystallization activation energy of less than or equal to about 600,000, 590,000, 580,000, 570,000, 560,000, 550,000, 540,000, 530,000, 520,000, 510,000, 500,000, 490,000, 480,000, 470,000, 460,000, 450,000, 440,000, 430,000, 420,000, 410,000, 400,000, 390,000, 380,000, 370,000, 360,000, 350,000, 340,000, 330,000, 320,000, 310,000, 300,000, 290,000, 280,000, 270,000, 260,000, or 250,000 J/mol, or any range derivable therein, as determined by isothermal differential scanning calorimetry (DSC) testing according to ASTM D3418-15 combined with Avrami kinetics fits (see e.g., Example 4).

In certain embodiments, a polypropylene has an absolute value for crystallization activation energy that is less than or equal to 90, 89, 88, 87, 86, 85, 84, 83, 82, 81, 80, 79, 78, 77, 76, 75, 74, 73, 72, 71, 70, 69, 68, 67, 66, or 65%, or any range derivable therein, of the absolute value for crystallization activation energy of an unnucleated Ziegler-Natta homopolymer polypropylene (see e.g., Example 4).

In certain embodiments, a polypropylene is a polypropylene copolymer. In certain embodiments, a polypropylene is a propylene-ethylene random copolymer. In some particular aspects, the polypropylene copolymer can be an isotactic propylene-ethylene random copolymer. In some particular aspects, the polypropylene copolymer can be a syndiotactic homopolymer polypropylene.

In some embodiments, a propylene copolymer can include 0.1 wt. % to 10 wt. %, or 0.1 wt % to 9 wt. %, or 0.1 wt. % to 8 wt. %, or 0.1 wt. % to 7 wt. %, or 0.1 wt. % to 6 wt. %, or 0.1 wt. % to 5 wt. %, or 0.1 wt % to 4 wt %, or 0.1 wt. % to 3 wt. % or 0.1 wt. % to 2 wt. % or at least any one of, equal to any one of, or between any two of 0.1, 0.2, 0.4, 0.6, 0.8, 1, 2, 3, 4, 5, 6, 7, 8, 9, or 10 wt. % of ethylene units and 90 wt. % to 99.9 wt. %, or 91 wt. % to 99.9 wt. %, or 92 wt. % to 99.9 wt. %, or 93 wt. % to 99.9 wt. %, or 94 wt. % to 99.9 wt. %, or 95 wt. % to 99.9 wt. %, or 96 wt. % to 99.9 wt. %, or 97 wt. % to 99.9 wt. %, or 98 wt. % to 99.9 wt. % or at least any one of, equal to any one of, or between any two of 90, 91, 92, 93, 94, 95, 96, 97, 98, 99, 99.2, 99.4, 99.6, 99.8 and 99.9 wt. % of propylene units, based on the total weight of the copolymer.

In some aspects, a polypropylene copolymer can have a xylene soluble content of less than 8 wt. % such as 1 wt. % to 8 wt. % or at least any one of, equal to any one of, or between any two of 1, 2, 3, 4, 5, 6, 7, and 8 wt. %.

In some aspects, the polypropylene can have a polydispersity (Mw/Mn) of 3 to 15 or at least any one of, equal to any one of, or between any two of 3, 4, 5, 6, 7, 8, 9, 10, 11, 12, 13, 14 and 15, wherein the polydispersity is measured using gel permeation chromatography (GPC).

In some aspects, the polypropylene can have a melt flow rate (MFR) of 0.1 g/10 min to 150 g/10 min, or 1 to 60 g/10 min, or 1 to about 30 g/10 min, or 1 to about 10 g/10 min, or 1 to about 7 g/10 min, or at least any one of, equal to any one of, or between any two of 0.1, 1, 2, 3, 4, 5, 6, 7, 8, 9, 10, 20, 30, 40, 50, 60, 70, 80, 90, 100, 110, 120, 130, 140, 150 and 160 g/10 min at 230° C., 2.16 kg measured in accordance with ASTM D-1238-20. In some aspects, the polypropylene can have a density of 0.90 g/cc to 1 g/cc, or 0.90 to 0.93 g/cc, or 0.90 g/cc to 0.92 g/cc, or 0.90 g/cc to 0.91, or at least any one of, equal to any one of, or between any two of 0.9, 0.902, 0.904, 0.906, 0.908, 0.91, 0.915, 0.92, 0.925, 0.93, 0.935, 0.94, 0.945, 0.95, 0.955, 0.96, 0.965, 0.97, 0.975, 0.98, 0.985, 0.99, 0.995 and 1 g/cc as measured in accordance with ASTM D1505-18. In some aspects, the polypropylene can have a combination of any or all of the properties mentioned herein.

In some embodiments, the polypropylene can have a flexural modulus of 100 Kpsi to 300 Kpsi at 4-8 N as determined by ASTM D790-97. In some aspects, the polypropylene can have a notched Izod impact strength greater than 0.9 ft-lb/in, such as 1 ft-lb/in to 1.5 ft-lb/in at 23° C., as measured in accordance with D638. In some aspects, the polypropylene can have a tensile modulus greater than 210 KPsi, such as 211 KPsi to 300 KPsi at 23° C., as measured in accordance with D 638. In some embodiments, the polypropylene can have an elongation at break greater than, equal to, or less than 10%, such as 5%, 6%, 7%, 8%, 9%, 10%, 11%, 12%, 13%, 14%, 15%, 16%, 17%, 18%, 19%, 20%, 30%, 40%, 50%, 60%, 70%, 80%, 90%, 100%, 120%, 140%, 160%, 180%, 200%, 250%, 300%, 350%, 400%, 450%, 500%, 550%, 600%, 650%, 700%, 750%, or any range derivable herein, at 23° C., as measured in accordance with D-638.

In some embodiments, the polypropylene copolymer can be prepared via conventional polymerization processes such as those known in the art. Examples of such polymerization processes include but are not limited to, slurry, liquid-bulk, and gas-phase polymerizations. In some embodiments, in slurry polymerization processes, polymerization occurs in the presence of a solvent, e.g. hexane, within a loop or continuous stirred tank reactor. In some embodiments, polymerization may also be carried out by bulk-phase polymerization, where liquid propylene and ethylene serve as both monomer and diluent. In some embodiments, in a typical bulk process, one or more loop reactors are generally employed. In other aspects, the copolymer may be produced by gas phase polymerization of propylene and ethylene, which is typically carried out in a fluidized bed reactor. In some embodiments, polymer fluff or powder produced from the polymerization reaction can be removed from the reactor and can then be processed via conventional techniques, such as by extrusion, to produce the desired copolymer pellets. The amount of ethylene monomer used during polymerization of the copolymer is desirably in proportion to the desired final ethylene content of the target propylene copolymer. In some embodiments the ethylene content during polymerization can range from 0.1 to 10 wt. %, or 0.1 to 9 wt. %, or 0.1 to 8 wt. %, or 0.1 to 7 wt. %, or 0.1 to 6 wt. %, or 0.1 to 5 wt. %, or 0.1 to 4 wt. %, or 0.1 to about 3 wt. % or 0.1 to about 2 wt. %, or 0.1 to about 1 wt. %, based on the total weight of the monomers, e.g. ethylene and propylene, present during polymerization. In some aspects, the polypropylene copolymer, such as propylene-ethylene random copolymer can be prepared using metallocene catalysts or Ziegler-Natta catalyst. In some embodiments, the polypropylenes are without nucleators. In some embodiments, the exclusion of nucleators avoids confounding base resin behavior with behavior enhanced by such additives.

In some embodiments, Ziegler-Natta catalysts are useful in the preparation of isotactic polypropylene. In some embodiments, these catalysts can be derived from a halide of a transition metal, such as titanium, chromium or vanadium with a metal hydride and/or metal alkyl, typically an organoaluminum compound, as a co-catalyst. In some aspects, the catalyst may contain a titanium halide supported on a magnesium compound. In some embodiments, a Ziegler-Natta catalysts, such as titanium tetrachloride (TiCl₄) supported on an active magnesium dihalide, such as magnesium dichloride or magnesium dibromide, as disclosed, for example, in U.S. Pat. Nos. 4,298,718 and 4,544,717, both to Mayr et al., and which are herein incorporated by reference, are supported catalysts. In some embodiments, silica may also be used as a support. In some embodiments, a supported catalyst may be employed in conjunction with a co-catalyst or electron donor such as an alkylaluminum compound, for example, triethylaluminum (TEAL), trimethyl aluminum (TMA) and triisobutyl aluminum (TIBAL).

### 2. Polypropylene 3270

In certain embodiments, a polypropylene is polypropylene 3270. In certain embodiments, a polypropylene is not polypropylene 3270. In certain embodiments, Polypropylene 3270 is a reference polypropylene. Polypropylene 3270 is produced by TotalEnergies which utilizes proprietary process technology to provide extremely low residuals for exceptional stiffness. Polypropylene 3270 is a high crystallinity homopolymer polypropylene. This polymer is made with a Ziegler-Natta catalyst, and Xylene solubles are <1%.

TABLE 1
Polypropylene 3270 properties

| | | |
|---|---|---|
| Method | Unit | Typical Value |

Rheological Properties

| | | | |
|---|---|---|---|
| Melt Flow | D-1238 | g/10 min | 2.0 |

Film Properties, Oriented

| | | | |
|---|---|---|---|
| Haze | D-1003 | % | 1.0 |
| Gloss, 45° | D-2457 | % | 85 |
| Ultimate Tensile | D-882 | Psi MD (TD) | 28,000 (39,000) |
| Elongation | D-882 | % MD (TD) | 150 (60) |
| Tensile Modulus | D-882 | Psi MD (TD) | 420,000 (700,000) |
| WVTR @ | F-1249-90 | g/100 in²/ | 0.2 |
| 100° F., 90% RH | | 24 hrs/mil | |

Thermal properties

| | | | |
|---|---|---|---|
| Melting Point | DSC | ° F. (° C.) | 329 (165) |

Other Physical Properties

| | | | |
|---|---|---|---|
| Density | D-1505 | g/cc | 0.91 |

### 3. Polypropylene 3276

In certain embodiments, a polypropylene is polypropylene 3276. In certain embodiments, a polypropylene is not polypropylene 3276. In certain embodiments, Polypropylene 3276 is a reference polypropylene. Polypropylene 3276 is produced by TotalEnergies which utilizes proprietary process technology to provide extremely low residuals for improved color stability and clarity. Polypropylene 3276 is a homopolymer polypropylene that is made with a Ziegler-Natta catalyst. The polymer is less stereoregular than 3270, as exemplified by a typical xylene solubles level of about 4%.

TABLE 2
Polypropylene 3276 properties

| | | |
|---|---|---|
| Method | Unit | Typical Value |

Rheological Properties

| | | | |
|---|---|---|---|
| Melt Flow | D-1238 (230° | g/10 min | 2.0 |
| | C./2160 g) | | |

Film Properties, Oriented

| | | | |
|---|---|---|---|
| Haze | D-1003 | % | 1.0 |
| Gloss, 45° | D-2457 | % | 85 |
| Ultimate Tensile | D-882 | Psi MD (TD) | 22,000 (35,000) |
| Elongation | D-882 | % MD (TD) | 150 (60) |
| Tensile Modulus | D-882 | Psi MD (TD) | 350,000 (600,000) |
| WVTR @ | F-1249-90 | g/100 in²/ | 0.3 |
| 100° F., 90% RH | | 24 hrs/mil | |

Thermal properties

| | | | |
|---|---|---|---|
| Melting Point | DSC | ° F. (° C.) | 325 (163) |

Other Physical Properties

| | | | |
|---|---|---|---|
| Density | D-1505 | g/cc | 0.905 |

### 4. Polypropylene Z9450

In certain embodiments, a polypropylene is polypropylene Z9450. In certain embodiments, a polypropylene is not polypropylene Z9450. In certain embodiments, Polypropylene Z9450 is a reference polypropylene. Polypropylene Z9450 is produced by TotalEnergies, and is a low melting, high ethylene random copolymer with improved color, optic, and impact properties. Polypropylene Z9450 has a low melting point, which in some embodiments, makes it an excellent heat seal layer. Polypropylene Z9450 is a random copolymer. The comonomer is ethylene and is typically incorporated at about 6 weight % level. The melting point is typically about 129° C. The polymer is made with a Ziegler-Natta catalyst.

TABLE 3
Polypropylene Z9450 properties

| | | |
|---|---|---|
| Method | Unit | Typical Value |

Rheological Properties

| | | | |
|---|---|---|---|
| Melt Flow | D-1238 | g/10 min | 5.0 |

Film Properties, Oriented

| | | | |
|---|---|---|---|
| Haze | D-1003 | % | 2.0 |
| Gloss, 45° | D-2457 | % | 85 |
| Ultimate Tensile | D-882 | Psi (MPa) | 2,500 (17) |
| 1% Secant Modulus | D-882 | Psi (MPa) | 50,000 (345) |
| Dart Impact (F50) | D-1709 | g/mil | 270 |
| WVTR @ | F-1249-90 | g/100 in²/ | 1.2 |
| 100° F., 90% RH | | 24 hrs/mil | |

Thermal properties

| | | | |
|---|---|---|---|
| Melting Point | DSC | ° F. (° C.) | 264 (129) |
| Heat seal temperature | — | ° F. (° C.) | 234 (112) |

Other Physical Properties

| | | | |
|---|---|---|---|
| Density | D-1505 | g/cc | 0.89 |

### 5. Polypropylene M9675

In certain embodiments, a polypropylene is polypropylene M9675. In certain embodiments, a polypropylene is not polypropylene M9675. In certain embodiments, Polypropylene M9675 is a reference polypropylene. Polypropylene M9675 is produced by TotalEnergies, and is an isotactic propylene copolymer produced using a metallocene catalyst. Polypropylene M9675 produces films with excellent heat seal performance and outstanding optical properties. Polypropylene M9675 is a random copolymer. The comonomer is ethylene and is typically incorporated at about 3 weight % level. The melting point is typically about 119° C., and xylene solubles are typically <1%.

TABLE 4
Polypropylene M9675 properties

| | | |
|---|---|---|
| Method | Unit | Typical Value |

Rheological Properties

| | | | |
|---|---|---|---|
| Melt Flow | D-1238 | g/10 min | 11 |

Film Properties, Oriented

| | | | |
|---|---|---|---|
| Haze | D-1003 | % | 0.2 |
| Gloss, 45° | D-2457 | % | 70 |
| Ultimate Tensile | D-882 | Psi | 4,500 |
| Elongation at break | D-882 | % | 700 |
| 1% Secant Modulus | D-882 | Psi | 55,000 |

Thermal properties

| | | | |
|---|---|---|---|
| Melting Point | DSC | ° F. (° C.) | 246 (119) |
| Heat seal temperature | SIT | ° F. (° C.) | 221 (105) |

Other Physical Properties

| | | | |
|---|---|---|---|
| Density | D-1505 | g/cc | 0.90 |

### 6. Polypropylene 1251

In certain embodiments, a polypropylene is polypropylene 1251. In certain embodiments, a polypropylene is not polypropylene 1251. In certain embodiments, Polypropylene 1251 is a reference polypropylene. Polypropylene 1251 is produced by TotalEnergies, and is a syndiotactic form of copolymer polypropylene. In some embodiments, syndiotactic polypropylenes have a lower melting, and/or lower crystallinity relative to other types of polypropylene. Polypropylene 1251 is a syndiotactic homopolymer polypropylene. The melting point is typically about 130° C., and the polymer is made with a metallocene catalyst.

TABLE 5
Polypropylene 1251 properties

| | | |
|---|---|---|
| | | Typical |
| Method | Unit | Value |

Rheological Properties

| | | | |
|---|---|---|---|
| Melt Flow | D-1238 | g/10 min | 2.2 |

Film Properties, Oriented

| | | | |
|---|---|---|---|
| Tensile | D-638 | Psi (MPa) | 2,200 (15) |
| Elongation @ Yield (break) | D-790 | % | 11 (250) |
| Tensile Modulus | D-638 | Psi (MPa) | 70,000 (480) |
| Flexural Modulus | D-790 | Psi (MPa) | 50,000 (340) |
| Izod Impact Notched @ 73° F. | D-256A | Ft.-lbs/in. (J/m) | 12 (640) |

Thermal properties

| | | | |
|---|---|---|---|
| Melting Point | DSC | ° F. (° C.) | 265 (130) |

Other Physical Properties

| | | | |
|---|---|---|---|
| Density | D-1505 | g/cc | 0.88 |
| Yellowness Index | D-1925 | — | −3.7 |

### 7. Clarifying Agent

In some embodiments, a composition of the present disclosure may include a phosphate ester salt containing clarifying agent and/or an aryl amide containing clarifying agent.

Non-limiting examples of phosphate ester salt containing clarifying agent include 2.2-methylene-bis(4,6-ditertbutylphenyl)phosphate, and/or aluminum hydroxybis(2,4,8,10-tetrakis(1,1-dimethyl) 6-hydroxy-12H-dibenzo[d,g][1,2,3][dioxaphophocin 6-oxidato]. In some particular the clarifying agent can be 2,2-methylene-bis(4,6-ditertbutylphenyl)phosphate. Examples of commercially available phosphate ester salts containing clarifying agents include, without limitation, ADK STABILIZER NA-71 and ADK STABILIZER NA-21, both available from Amfine Chemical Corp., Allendale, N.J.

Non-limiting examples of the aryl amide containing clarifying agent can be a 1,3,5-benzenetrisamide amide derivative. In some aspects, the aryl amide containing clarifying agent can be (1,3,5-tris(2,2-dimethyl propanamido)benzene. Examples of commercially available aryl amide containing clarifying agents include, without limitation, IRGACLEAR XT 386 available from BASF.

In some embodiments, a composition of the present disclosure can be free of, or essentially free of, such as contain less than 100 ppm, or less than 50 ppm or less than 10 ppm of clarifying agents containing sorbitol or sorbitol derivative, nonitol or nonitol derivative, and/or xylitol or xylitol derivative.

### 8. Additives

In some embodiments, a composition can further contain one or more additives selected from antioxidants, stabilizers, neutralizers, processing aids, peroxides, slip agents and/or antistatics. In some embodiments, one or more additives can be selected from, but is not limited to, an antioxidant, an acid neutralizer, an antistatic agent, an antiblock agent, an antifog agent, an anticorrosion agent, a clarifying agent, a ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combination thereof. Additives are available from various commercial suppliers. Non-limiting examples of commercial additive suppliers include BASF (Germany), Dover Chemical Corporation (U.S.A.), AkzoNobel (The Netherlands), Sigma-Aldrich® (U.S.A.), Atofina Chemicals, Inc., and the like.

In some embodiments, a composition can contain i) 50 ppm to 500 ppm or at least any one of, equal to any one of, or between any two of 50, 100, 200, 300, 400 and 500 ppm of an antioxidant, ii) 200 ppm to 2000 ppm or at least any one of, equal to any one of, or between any two of 200, 400, 600, 800, 1000, 1200, 1400, 1600, 1800 and 2000 ppm of a stabilizer, iii) 200 ppm to 2000 ppm or at least any one of, equal to any one of, or between any two of 200, 400, 600, 800, 1000, 1200, 1400, 1600, 1800 and 2000 ppm of a antistatic, and iv) 100 ppm to 1000 ppm or at least any one of, equal to any one of, or between any two of 100, 200, 400, 600, 800, and 1000 ppm of a neutralizer, or any combination thereof.

In some embodiments, an antioxidant can be a sterically hindered phenol and/or a phosphite containing antioxidant. In some embodiments, a combination of antioxidants can be used. In some aspects, the sterically hindered phenol antioxidant can be pentaerythritol tetrakis[3-[3,5-di-tert-butyl-4-hydroxyphenyl]propionate, octadecyl-3-[3,5-di-tert-butyl-4-hydroxyphenyl]propionate], pentaerythritol tetrakis [3-[3,5-di-tert-butyl-4-hydroxyphenyl]propionate, or 1,3,5-tris(3,5-di-tert-butyl-4-hydroxybenzyl)-1,3,5-triazine-2,4,6(1H,3H,5H)-trione, or any combinations thereof. In some aspects, the phosphite containing antioxidant can be tris(2,4-di-tert-butylphenyl)phosphite, bis (2,4-dicumylphenyl) pentaerythritol diphosphate, or bis (2,4-di-t-butylphenyl) pentraerythritol diphosphate or any combination thereof. In some particular aspects, the antioxidant can be pentaerythritol tetrakis[3-[3,5-di-tert-butyl-4-hydroxyphenyl]propionate. In some embodiments, the stabilizer can be a phosphite containing stabilizer and/or oligomeric hindered amine containing stabilizer. In some aspects, the phosphite containing stabilizer can be tris(2,4-di-tert-butylphenyl)phosphite. In some aspects, the oligomeric hindered amine containing stabilizer can be butanedioic acid, dimethylester, polymer with 4-hydroxy-2,2,6,6-tetramethyl-1-piperidine ethanol. In some particular aspects, the stabilizer can be tris(2,4-di-tert-butylphenyl)phosphite. In some aspects, the antistatic can be glycerol monostearate. In some embodiments, the glycerol monostearate can have a monoester content of 45 to 90 wt. % or at least any one of, equal to any one of, or between any two of 45, 50, 55, 60, 65, 70, 75, 80, 85 and 90 wt. %. In some embodiments, the neutralizer can be a stearate containing neutralizer, hydrotalcite, zinc oxide, or sodium benzoate, or any combinations thereof. In some embodiments, the stearate containing neutralizer can be calcium stearate, and/or zinc stearate. In some particular aspects, the neutralizer can be a stearate containing neutralizer such as calcium stearate, and/or zinc stearate.

In some aspects, a composition can contain 50 ppm to 500 ppm of a sterically hindered phenol, such as pentaerythritol tetrakis[3-[3,5-di-tert-butyl-4-hydroxyphenyl]propionate, 200 ppm to 2000 ppm of a phosphite containing stabilizer such as tris(2,4-di-tert-butylphenyl)phosphite, 200 ppm to 2000 ppm of an ester containing antistatic, such as glycerol monostearate, or 100 ppm to 1000 ppm of a stearate such as calcium stearate, and/or zinc stearate or any combinations thereof.

### C. Methods of Making Polypropylenes AM Products Comprising Polypropylene

Methods of producing the polypropylenes for use according to the current disclosure can include various methods known in the art such as but not limited to a “high pressure” process, a slurry process, a solution process, a gas phase process, or combinations thereof. In some embodiments, a process for making a polypropylene comprises the use of heat, pressure, one or more monomers, and one or more catalysts, with optional additional additives and/or optional cross-polymers. For example, the components, such as the monomers (e.g., propylene, ethylene, xylene, etc.), optionally with one or more catalysts (e.g., including but not limited to Ziegler Natta catalysts, chromium or Phillips catalysts, single site catalysts, metallocene catalysts, and the like), and optionally with one or more additives, can be mixed, such as but not limited to dry blending, and then melt-blended, such as but not limited to extrusion to form a polymeric composition. In some embodiments, a polypropylene is produced through the use of a high pressure process, a slurry process, a solution process, a gas phase process, or combinations thereof. In some embodiments, a reactor powder can then be subjected to downstream processes to introduce additives. In some embodiments, reactor powder is formed into polypropylene pellets via an extrusion process, injection molding, and/or thermoforming.

In some embodiments, a polypropylene may be formed by placing one or more monomer (e.g., propylene) alone or with other monomers and/or additives in a suitable reaction vessel in the presence of a catalyst (e.g., Ziegler-Natta, metallocene, etc.) and under suitable reaction conditions for polymerization thereof. Any suitable equipment and processes for polymerizing the propylene into a polymer may be used. For example, such processes may include solution phase, gas phase, slurry phase, bulk phase, high pressure processes or combinations thereof. Such processes are described in detail in U.S. Pat. Nos. 5,525,678; 6,420,580; 6,380,328; 6,359,072; 6,346,586; 6,340,730; 6,339,134; 6,300,436; 6,274,684; 6,271,323; 6,248,845; 6,245,868; 6,245,705; 6,242,545; 6,211,105; 6,207,606; 6,180,735; and 6,147,173, which are incorporated herein by reference in their entirety.

In some embodiments, a polypropylene can be formed by a gas phase polymerization process. One non-limiting example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from 100 psig to 500 psig, or from 200 psig to 400 psig, or from 250 psig to 350 psig. The reactor temperature in a gas phase process can be from 30° C. to 120° C. or from 60° C. to 115° C., or from 70° C. to 110° C., or from 70° C. to 95° C. Non-limiting examples of polymer processes are described in U.S. Pat. Nos. 4,543,399; 4,588,790; 5,028,670; 5,317,036; 5,352,749; 5,405,922; 5,436,304; 5,456,471; 5,462,999; 5,616,661; 5,627,242; 5,665,818; 5,677,375; and 5,668,228, which are incorporated herein by reference in their entirety.

In some aspects, a polypropylene to be comprised in an AM article and/or method of making an AM article can be formed by extrusion of a molten polymeric composition through a slot or die and cooling e.g. quenching the extrudate to form the initial article e.g., the extruded sheet (for example but not limited to, an extruded ribbon). In some embodiments, Extrusion of the molten polypropylene can occur at a temperature ranging from 120° C. to 315° C. or at least any one of, equal to any one of, or between any two of 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., 300° C., 310° C., and 315° C. In some aspects, the extruded sheet can have a thickness of 0.5 to 100 mm, 12 to 20 mm, 12 to 16 mm, or 16 to 20 mm or at least any one of, equal to any one of, or between any two of 0.5, 1, 2, 4, 6, 8, 10, 12, 14, 16, 18, 20, 30, 40, 50, 60, 70, 80, 90 and 100 mm. In some aspects, the initial article can be a multilayer extruded sheet and each layer of the multilayer extruded sheet can independently have a thickness of 0.5 to 100 mm, 12 to 20 mm, 12 to 16 mm, or 16 to 20 mm or at least any one of, equal to any one of, or between any two of 0.5, 1, 2, 4, 6, 8, 10, 12, 14, 16, 18, 20, 30, 40, 50, 60, 70, 80, 90 and 100 mm.

In some aspects, additive manufactured products comprising polypropylenes and/or methods of creating additive manufactured products comprising polypropylenes comprises use of a polypropylene that was in the form of a filament. In some embodiments, a polypropylene filament can be 1.75 mm in diameter. In some embodiments, a polypropylene filament can be 2.85 mm in diameter. In some embodiments, a polypropylene filament greater than, less than, or is about 1.5, 1.55, 1.6, 1.65, 1.7, 1.75, 1.8, 1.85, 1.9, 1.95, 2.0, 2.05, 2.1, 2.15, 2.2, 2.25, 2.3, 2.35, 2.4, 2.45, 2.5, 2.55, 2.6, 2.65, 2.7, 2.75, 2.8, 2.85, 2.9, 2.95, 3, 3.05, 3.1, 3.15, 3.2, 3.25, 3.3, 3.35, 3.4, 3.45, or 3.5 mm, or any range derivable therein.

In some aspects, additive manufactured products comprising polypropylenes and/or methods of creating additive manufactured products comprising polypropylenes comprises use of a polypropylene that was in the form of a powder and/or particulate. In some embodiments, a polypropylene powder and/or particulate has an average particle size of 1 μm to 500 μm. In some embodiments, a polypropylene powder and/or particulate has an average particle size of 15 μm to 100 μm. In some embodiments, a polypropylene powder and/or particulate has an average particle size of 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm, or any range derivable therein.

### D. AM Products Comprising Polypropylene and Methods of Making the Same

Described herein are additive manufactured products comprising polypropylene, methods of utilizing polypropylenes, and methods of creating additive manufactured products comprising polypropylenes. In some embodiments, additive manufactured products comprising polypropylenes, and/or methods of creating additive manufactured products can include any additive manufacturing methodology described herein, such as but not limited to, Fused Deposition Modelling and/or Selective Laser Sintering. The polypropylenes described in the present disclosure can be comprised in an article of manufacture. As outlined above, the article of manufacture is produced through additive manufacturing. In some aspects, the article of manufacture can be transparent, translucent, and/or opaque.

In some aspects, the additive manufactured products comprising polypropylene, methods of utilizing polypropylenes, and methods of creating additive manufactured products comprising polypropylenes comprises extrusion of a polypropylene from a nozzle. In some embodiments, a nozzle diameter is greater than, less than, or about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2.0 mm, or any range derivable therein. In some embodiments, a polypropylene a nozzle diameter is greater than 2.0 mm. In some embodiments, a polypropylene is in contact with a heated plate. In some embodiments, a polypropylene is in contact with a build plate.

In some aspects, the additive manufactured products comprising polypropylene, methods of utilizing polypropylenes, and methods of creating additive manufactured products comprising polypropylenes comprises layering of polypropylene powder and/or particulates. In some embodiments, a polypropylene powder and/or particulate has an average particle size of 1 μm to 500 μm. In some embodiments, a polypropylene powder and/or particulate has an average particle size of 15 μm to 100 μm. In some embodiments, a polypropylene powder and/or particulate has an average particle size of 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, or 500 μm, or any range derivable therein. In some embodiments, a polypropylene powder and/or particulate is comprised in a dust-tight and/or air-tight container to prevent accidental spillage and/or leakage. In some embodiments, a polypropylene powder and/or particulate comprises additives to mitigate static electricity. In some embodiments, polypropylene powder and/or particulate morphology and particle size distribution are carefully controlled for production consistency. In some embodiments, a polypropylene powder and/or particulate is cryogenically ground followed by dissolution-precipitation to effectively control particle size.

Non-limited examples of the article of the articles of manufacture include housewares, food storage containers, cooking utensils, plates, cups, measuring cups, drinking cups, strainers, turkey basters, non-food storage containers, filing cabinets and particularly clear drawers used in such cabinets, general storage devices, such as organizers, totes, sweater boxes, films, coatings and fibers, bags, adhesives, yarns, fabrics, bottles, jars, plates and cups, clamshell and the like. In certain embodiments, an article of manufacture can be rigid packaging, such as deli containers and lids including those used for dips, spreads, and pasta salads, dairy containers and lids including those used for storing cottage cheese, butter and yogurt, personal care products, and bottles and jars. In certain embodiments, an article of manufacture can be an automobile part, building material part, insulation part, electric instrument part, furniture part, textile part, container part, home appliance part, medical part, sports equipment, prosthetic, filter media, and/or custom toy.

In these and other uses, the polypropylene may be combined with other materials, such as particulate materials, including talc, calcium carbonate, wood, and fibers, such as glass or graphite fibers, etc. to form composite materials. Examples of such composite materials include components for furniture, automotive components and building materials, particularly those used as lumber replacement.

### E. Recitation of Aspects

Certain embodiments of the present invention are characterized through the following enumerated aspects.
Aspect 1, is an additive manufactured article comprising one or more polypropylene (PP) with one or more of the following properties: a) a melting temperature≤135° C., measured according to ASTM D3418-15; b) an onset of melting temperature≤125° C., measured according to ASTM D3418-15; c) an onset of crystallization temperature≤105° C., measured according to ASTM D3418-15; d) crystallinity of ≤35%, measured according to ASTM D3418-15; e) an Avrami exponent≤2.10; f) an absolute value for crystallization activation energy≤550,000 J/mol, as determined from Avrami kinetics fits; and/or g) an absolute value for crystallization activation energy that is less than or equal to 80% of the absolute value for crystallization activation energy of an unnucleated Ziegler-Natta homopolymer polypropylene.
Aspect 2, is the additive manufactured article of aspect 1, comprising one or more PP with one or more of the following characteristics: a) a melting temperature≤130° C., measured according to ASTM D3418-15; b) an onset of melting temperature≤120° C., measured according to ASTM D3418-15; c) an onset of crystallization temperature≤100° C., measured according to ASTM D3418-15; d) crystallinity of ≤30%, measured according to ASTM D3418-15; e) an Avrami exponent≤2.05; f) an absolute value for crystallization activation energy≤500,000 J/mol, as determined from Avrami kinetics fits; and/or g) an absolute value for crystallization activation energy that is less than or equal to 75% of the absolute value for crystallization activation energy of an unnucleated Ziegler-Natta homopolymer polypropylene.
Aspect 3, is the additive manufactured article of aspects 1 or 2, comprising one or more PP with at least two of the following characteristics: a) a melting temperature≤135° C. or ≤130° C., measured according to ASTM D3418-15; b) an onset of melting temperature≤125° C. or ≤120° C., measured according to ASTM D3418-15; c) an onset of crystallization temperature≤105° C. or ≤100° C., measured according to ASTM D3418-15; and/or d) crystallinity of ≤35% or ≤30%, measured according to ASTM D3418-15.
Aspect 4, is the additive manufactured article of any one of aspects 1 to 3, wherein the at least one polypropylene is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.
Aspect 5, is the additive manufactured article of any one of aspects 1 to 4, wherein the PP has an absolute value for crystallization activation energy, as determined by isothermal differential scanning calorimetry (DSC) testing according to ASTM D3418-15 combined with Avrami kinetics fits, that are between about 300,000 J/mol to about 500,000 J/mol.
Aspect 6, is the additive manufactured article of any one of aspects 1 to 5, wherein the PP has a crystallinity of 35% to 15% based on a theoretical heat of fusion (ΔH₀ₘ) for 100% crystallized polypropylene of 207 J/g.
Aspect 7, is the additive manufactured article of any one of aspects 1 to 6, wherein the PP has a sintering window of 30° C. or lower, as defined by onset melting and crystallization temperatures.
Aspect 8, is the additive manufactured article of aspect 7, wherein the PP has a sintering window of 18° C. to 30° C.
Aspect 9, is the additive manufactured article of any one of aspects 1 to 8, wherein the PP has a density of 0.8 g/cc to 1 g/cc measured according to ASTM D1505-18, and/or melt flow rate (MFR) of 0.1 g/10 min to 100.0 g/10 min, measured according to ASTM D1238-20.
Aspect 10, is the additive manufactured article of any one of aspects 1-9, wherein the PP has a melt flow of 0.5 g/10 min to 30 g/min, measured according to ASTM D1238-20.
Aspect 11, is a method of making the additive manufactured article of any one of aspects 1 to 10, the method comprising melting and/or sintering a composition comprising the one or more PP.
Aspect 12, is the method of aspect 11, wherein the at least one polypropylene is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.
Aspect 13, is the method of aspect 11 or 12, wherein the article is made by sintering the PP in particulate form having an average particle size of 1 μm to 500 μm.
Aspect 14, is the method of aspect 13, wherein the particulate has an average particle size of 15 μm to 100 μm.
Aspect 15, is the method of any one of aspects 11-14, wherein the method comprises material extrusion, wherein the composition in a melted state is extruded through a nozzle and is deposited in layers.
Aspect 16, is the method of any one of aspects 11-14, wherein the method comprises sintering Aspect particles of the composition in a particulate form in a powder bed sintering (PBS) process.
Aspect 17, is the method of aspect 16, wherein the PBS process uses a layer thickness of 10 μm to 200 μm and/or a part bed temperature of 20° C. to 100° C.
Aspect 18, is the method of aspect 17, wherein the PBS process uses a layer thickness of 30 μm to 150 μm.
Aspect 19, is an article of manufacture comprising an additive manufactured article of any one of aspects 1-10, or made with the method of any one of aspects 11-18.
Aspect 20, is the article of aspect 19, wherein the article is an automobile part, building material part, insulation part, electric instrument part, furniture part, textile part, container part, home appliance part, medical part, prosthetic, filter media, and/or custom toy.
Aspect 21, is a composition for additive manufacturing, wherein the composition comprises at least one polypropylene (PP), and is in contact with at least one component designed for use in a 3-D printer, wherein the PP comprises one or more of the following properties: a) a melting temperature≤135° C., measured according to ASTM D3418-15; b) an onset of melting temperature≤125° C., measured according to ASTM D3418-15; c) an onset of crystallization temperature≤105° C., measured according to ASTM D3418-15; d) crystallinity of ≤35%, measured according to ASTM D3418-15; e) an Avrami exponent≤2.10; f) an absolute value for crystallization activation energy≤550,000 J/mol, as determined from Avrami kinetics fits; and/or g) an absolute value for crystallization activation energy that is less than or equal to 80% of the absolute value for crystallization activation energy of an unnucleated Ziegler-Natta homopolymer polypropylene.
Aspect 22, is the composition of aspect 21, comprising one or more polypropylene (PP) with one or more of the following characteristics: a) a melting temperature≤130° C., measured according to ASTM D3418-15; b) an onset of melting temperature≤120° C., measured according to ASTM D3418-15; c) an onset of crystallization temperature≤100° C., measured according to ASTM D3418-15; g) crystallinity of ≤30%, measured according to ASTM D3418-15; d) an Avrami exponent≤2.05; e) an absolute value for crystallization activation energy≤500,000 J/mol, as determined from Avrami kinetics fits; and/or f) an absolute value for crystallization activation energy that is less than or equal to 75% of the absolute value for crystallization activation energy of an unnucleated Ziegler-Natta homopolymer polypropylene.
Aspect 23, is the composition of aspects 21 or 22, comprising one or more PP with at least two of the following characteristics: a) a melting temperature≤135° C. or ≤130° C., measured according to ASTM D3418-15; b) an onset of melting temperature≤125° C. or ≤120° C., measured according to ASTM D3418-15; c) an onset of crystallization temperature≤105° C. or ≤100° C., measured according to ASTM D3418-15; and/or d) crystallinity of ≤35% or ≤30%, measured according to ASTM D3418-15.
Aspect 24, is the composition of any one of aspects 21 to 23, wherein the at least one PP is a Ziegler-Natta based random copolymer, metallocene random copolymer, and/or syndiotactic PP, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.
Aspect 25, is the composition of any one of aspects 21 to 24, comprising at least 95 wt. % of at least one PP.
Aspect 26, is the composition of any one of aspects 21 to 25, wherein the PP is in contact with a 0.4 mm extruder nozzle, a 0.35 mm extruder nozzle, a build plate, and/or a heated bed.
Aspect 27, is the composition of any one of aspects 21 to 26, wherein the PP has an absolute value for crystallization activation energy, as determined by isothermal differential scanning calorimetry (DSC) testing according to ASTM D3418-15 combined with Avrami kinetics fits, that are between about 300,000 J/mol to about 500,000 J/mol.
Aspect 28, is the composition of any one of aspects 21 to 27, wherein the PP has a crystallinity of 35% to 15% based on a theoretical heat of fusion (ΔH₀ₘ) for 100% crystallized polypropylene of 207 J/g.
Aspect 29, is the composition of any one of aspects 21 to 28, wherein the PP has a sintering window of 30° C. or lower, as defined by onset melting and crystallization temperatures.
Aspect 30, is the composition of aspect 29, wherein the PP has a sintering window of 18° C. to 30° C.
Aspect 31, is the composition of any one of aspects 21 to 30, wherein the PP has a density of 0.8 g/cc to 1 g/cc measured according to ASTM D1505-18, and/or melt flow of 0.1 g/10 min to 100 g/10 min, measured according to ASTM D1238-20.
Aspect 32, is the composition of aspect 31, wherein the PP has a melt flow of 0.5 g/10 min to 30 g/10 min.
Aspect 33, is the composition of any one of aspects 21 to 32, wherein the PP is in particulate form having an average particle size of 1 μm to 500 μm.
Aspect 34, is the composition of aspect 33, wherein the particulate has an average particle size of 15 μm to 100 μm.

### EXAMPLES

The present inventions will be described in greater detail by way of specific examples. The following examples are offered for illustrative purposes only, and are not intended to limit the inventions in any manner. Those of skill in the art will readily recognize a variety of noncritical parameters which can be changed or modified to yield essentially the same results.

### A. Example 1—Melting and Crystallization Temperatures

Typical melting temperatures (Tm) and crystallization temperatures (Tc) for polypropylenes 3270, 3276, Z9450, M9675, and 1251 were determined (see Table 6); these data are representative averages of greater than or equal to 10 different tests). The melting behavior was observed to not be uniform, and it reflects the malleability of thermal behavior tied back to the respective polypropylene's molecular architecture. The melting behavior was also related to overall crystallinity, as listed in the enthalpies of crystallization and melting (see Table 7; these data are representative averages of greater than or equal to 10 different tests). Such a diverse array of melting and crystallization temperatures offers the potential for certain polypropylenes to be advantaged in additive manufacturing.

TABLE 6
Melting temperature (Tm), crystallization temperature
(Tc) and temperature difference between PP grades.

| | | | Tm Std | | Tc Std | | Tm − Tc |
|---|---|---|---|---|---|---|---|
| | PP | Tm | Dev. | Tc | Dev. | Tm − Tc | Std Dev. |
| Grade | Type | (° C.) | (° C.) | (° C.) | (° C.) | (° C.) | (° C.) |
| 3270 | IZNHCH | 166.48 | 1.24 | 117.47 | 5.04 | 49.01 | 4.37 |
| 3276 | IZNH | 162.37 | 0.85 | 114.76 | 4.07 | 47.61 | 3.82 |
| Z9450 | ZNRC | 129.55 | 1.21 | 90.57 | 1.69 | 38.98 | 1.30 |
| M9675 | MRC | 122.36 | 1.75 | 82.38 | 2.55 | 39.97 | 1.85 |
| 1251 | SMH | 127.38 | 0.85 | 67.16 | 4.54 | 60.22 | 4.11 |

Melting temperature = Tm; Crystallization temperature = Tc; Isotactic Ziegler-Natta high crystallinity homopolymer = IZNHCH; Isotactic Ziegler-Natta homopolymer = IZNH; Ziegler-Natta random copolymer = ZNRC; Metallocene random copolymer = MRC; Syndiotactic metallocene homopolymer = SMH; Standard Deviation = Std Dev.

TABLE 7
Crystallization enthalpy (−ΔH_{c}) and melting
enthalpy (ΔHₘ) between PP grades.

| | | | −ΔHc | | | |
|---|---|---|---|---|---|---|
| | PP | −ΔHc | Std Dev. | ΔHm | ΔHm | Crystal- |
| Grade | Type | (J/g) | (J/g) | (J/g) | (J/g) | linity* |
| 3270 | IZNHCH | 106.50 | 5.00 | 110.11 | 6.22 | 53.19% |
| 3276 | IZNH | 94.22 | 4.88 | 95.85 | 11.60 | 46.30% |
| Z9450 | ZNRC | 53.76 | 6.18 | 53.62 | 8.02 | 25.90% |
| M9675 | MRC | 58.66 | 7.82 | 58.89 | 5.98 | 28.45% |
| 1251 | SMH | 28.05 | 4.53 | 34.74 | 4.97 | 16.78% |

Crystallization enthalpy = −ΔH_{c};
melting enthalpy = −ΔHₘ;
Joules per gram = J/g;
Isotactic Ziegler-Natta high crystallinity homopolymer = IZNHCH;
Isotactic Ziegler-Natta homopolymer = IZNH;
Ziegler-Natta random copolymer = ZNRC;
Metallocene random copolymer = MRC;
Syndiotactic metallocene homopolymer = SMH;
Standard Deviation = Std Dev.;
*Based on a theoretical heat of fusion (ΔH₀ₘ) for 100% crystallized polypropylene of 207 J/g.

Three homopolymer grades are listed in Tables 6 and 7: 3270, 3276 and 1251. Evaluating these three grades highlights how between homopolymer grades, syndiotactic PP (1251) offered advantages over isotactic PP for AM, such as lower Tm, lower Tc, and/or larger Tm-Tc range. Regarding lower Tm, 1251 displayed a 35 to 40° C. lower melting. At the same time, the 127° C. melting temperature was well above water's boiling temperature, which is a typical lower bound for many applications. This lower Tm can offer an advantage in terms of lower energy utilization for FDM and SLS processes when compared to 3270 and 3276 or other alternative polypropylenes. Regarding lower Tc, 1251 crystalized at a temperature about 50° C. lower than alternative polypropylenes. The 67° C. crystallization temperature was beneficial, and may be especially so when printing in an ambient environment where the temperature is 25° C. This low crystallization temperature allowed a longer time for adjacent layers in an AM part to properly adhere. Strong adhesion can be beneficial for maximizing physical property performance. The lower Tc can be expected to allow for a cooler bed temperature and less stringent requirements for enclosing the printing area to maintain thermal consistency. Regarding larger Tm-Tc range, 1251 had a 60° C. range between melting and crystallization temperatures, >10° C. more than either Ziegler-Natta homopolymer.

A broader range can be beneficial because it can create a larger metastable regime, enhancing AM processing. This broader range can give a processor more control for making an article, helping in product consistency and resilience against natural manufacturing variance.

Similar claims can be made when comparing isotactic homopolymers against significantly lower melting random copolymers (RCPs). Specifically, Z9450 and M9675 both offered a number of advantages over isotactic PP, such as lower Tm and lower Tc. Regarding lower Tm, the RCPs had a >30° C. lower melting temperature, while still well above water's boiling temperature. This lower Tm offered an advantage in terms of lower energy utilization for FDM and/or SLS processes when compared to polypropylenes 3270 and/or 3276. Regarding lower Tc, the RCPs crystallize at ≥25° C. lower temperatures than the comparative isotactic PPs.

The lower crystallization temperature(s) allows a longer time for adjacent layers in an AM part to properly adhere and provide the best physical properties.

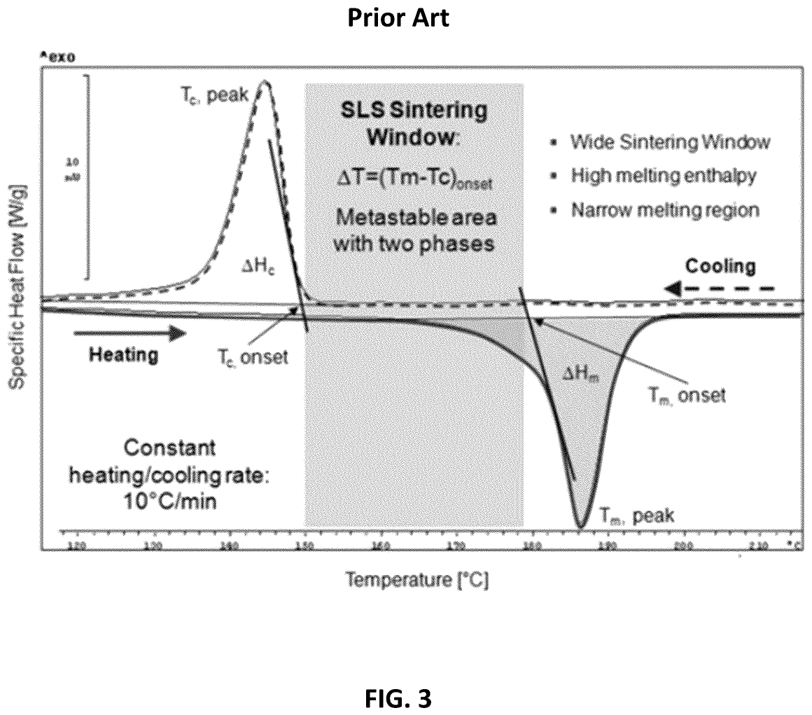

The analysis of Tc and Tm can be viewed as complementary approaches to quantifying the onset of crystallization and melting temperatures illustrated by Schmid and colleagues (see e.g., FIG. 3) for evaluating an AM processing window. For example, 3D Evaluate (A 3D alliances company) utilized this approach in discussing the processing window for SLS, as does Kuchnlein and colleagues (see e.g., “3D Evaluate—Sep. 21, 2020, “Why don't we see more polymers in SLS?” by Yehiel Shaham; and Kuchnlein et al., Degradation behavior and material properties of PA12-Plastic powders processed by powder based additive manufacturing technologies. Annals of DAAAM, 2010).

There are a number of factors that favor using Tc and Tm in screening polymers for AM. For example, peak melting and crystallization temperatures are more distinct, which helped in testing consistency. Measuring onset temperatures require, in some instances, fitting tangent lines to the peaks; such tangent lines can prove challenging and/or yield higher variance in cases where melting or crystallization behavior is diffuse and/or complex. Another advantage is that quantification of peak temperatures is a more common practice than quantification of onset temperatures. The onset temperatures can capture the key salient point of incipient phase transition, but can require additional education to those unfamiliar with the metric. For purposes of comparative screening and evaluation of PP types, the Tc and Tm measurements are instructive and have utility.

### B. Example 2—Melting and Crystallization DSC Traces

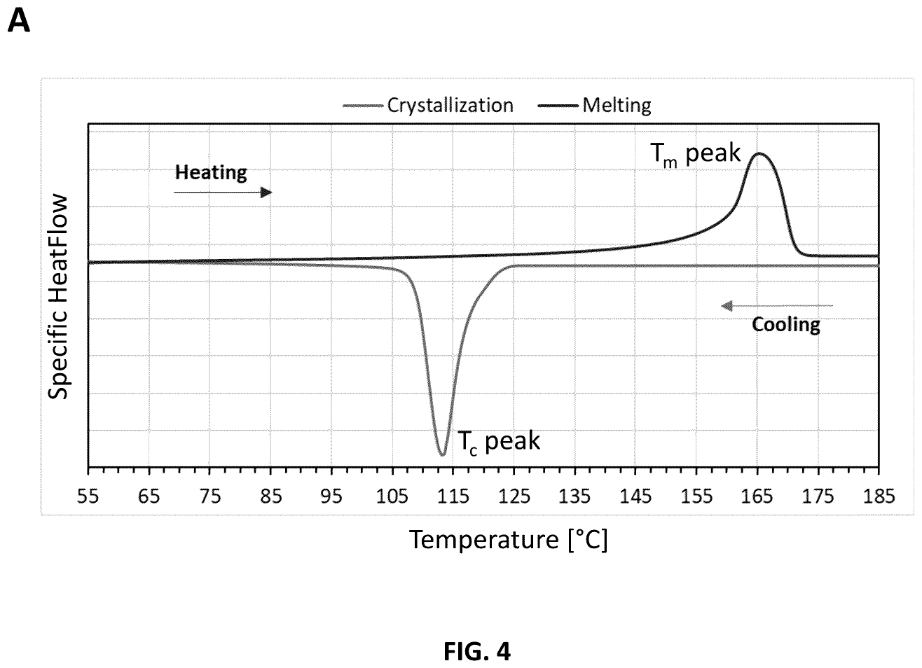

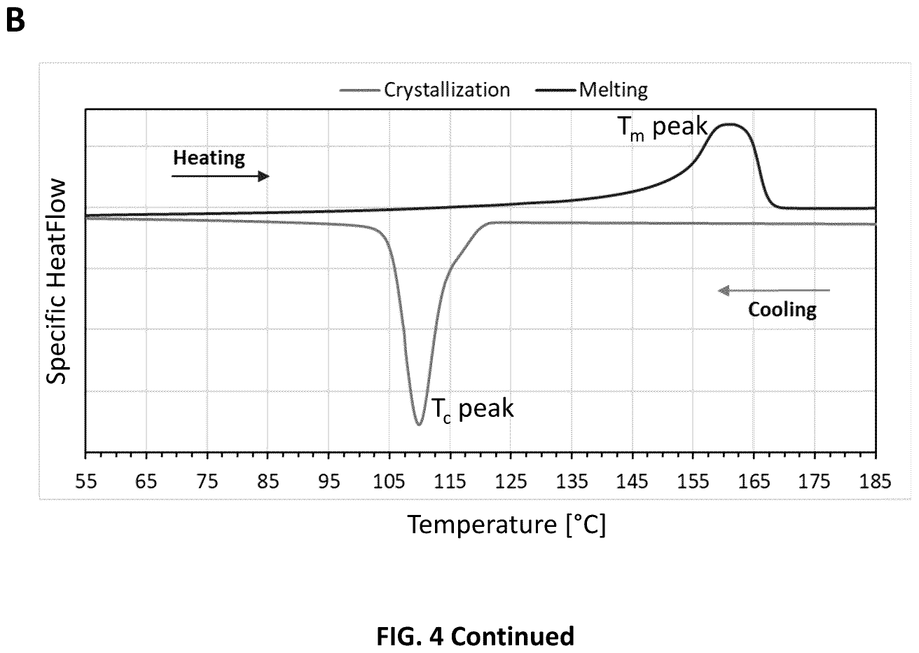

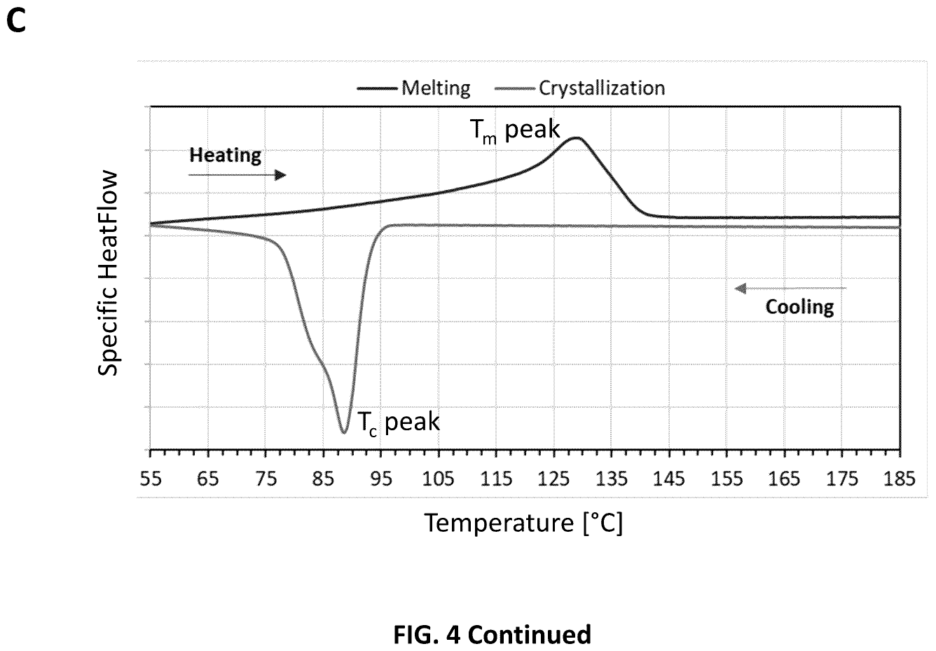

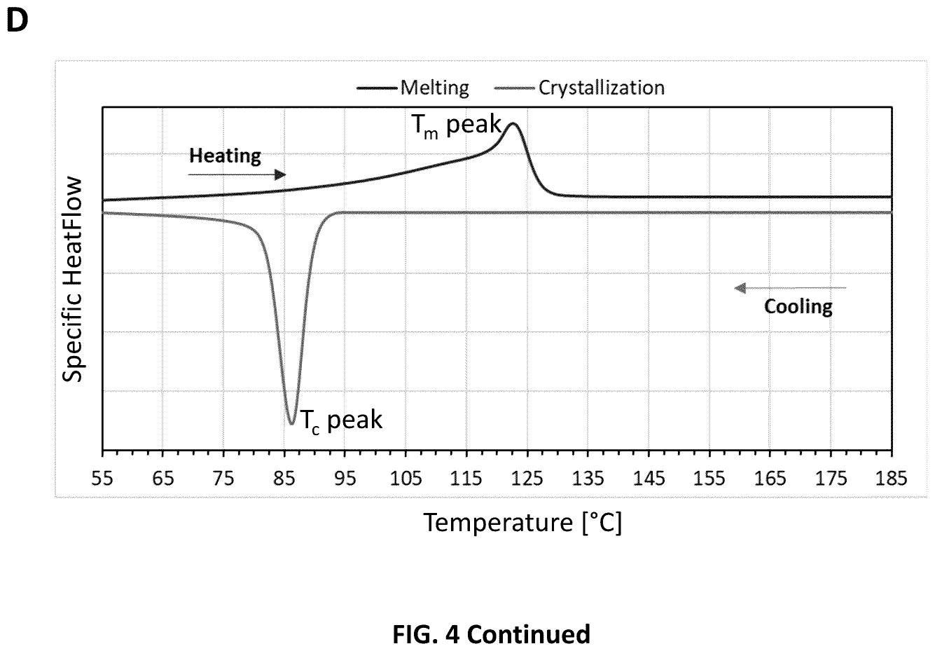

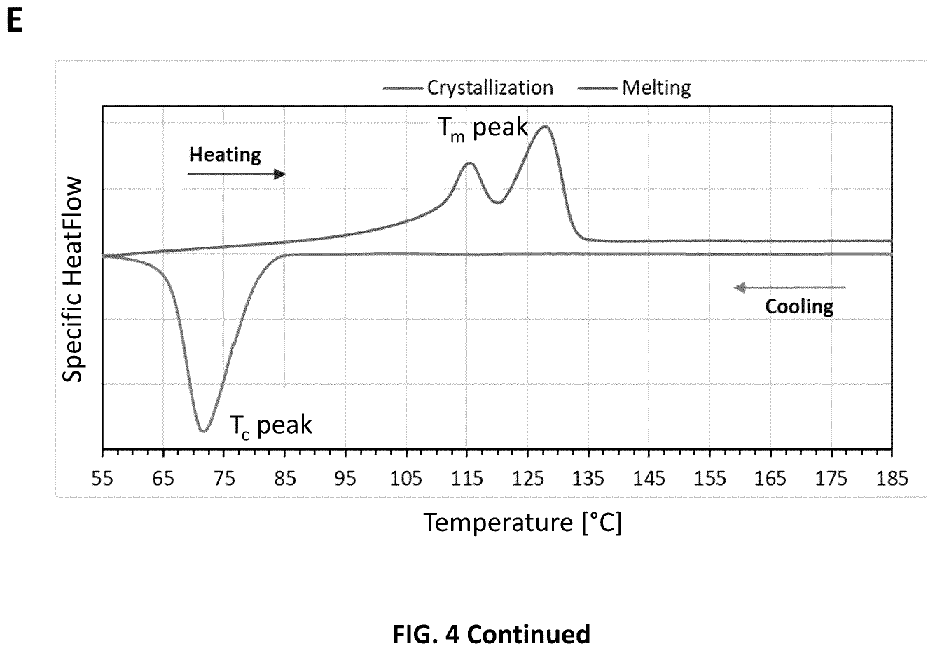

Representative DSC melting and crystallization traces were generated for a more nuanced view of crystallization and melting behavior (see FIGS. 4 A-E). Several general observations can be made from the data.

It was observed that melting peak shape can vary widely. The most extreme case is with 1251, which exhibited bimodal behavior. This illustrated the limitations of using a singular datum point like melting point in characterizing the melting behavior.

It was observed that melting peak can have a long lower temperature tail as the temperature was increased. The melting peak was not neatly symmetrical for any PP tested. All tested PPs had lower melting species that presented themselves as a peak shape which rose gradually at first. This rise grew with increasing temperature, accelerating until reaching an inflection point close to the peak melting temperature.

It was observed that crystallization peak shape can likewise vary. Although no clear bimodality was evident, it appears the process from incipient crystallization to bulk crystallization as Tc differed between the polymers. Of note, 1251 in particular appeared to have a broader temperature range from incipient crystallization to broad, bulk crystallization.

### C. Example 3—Onset Temperatures and Metastable Regions

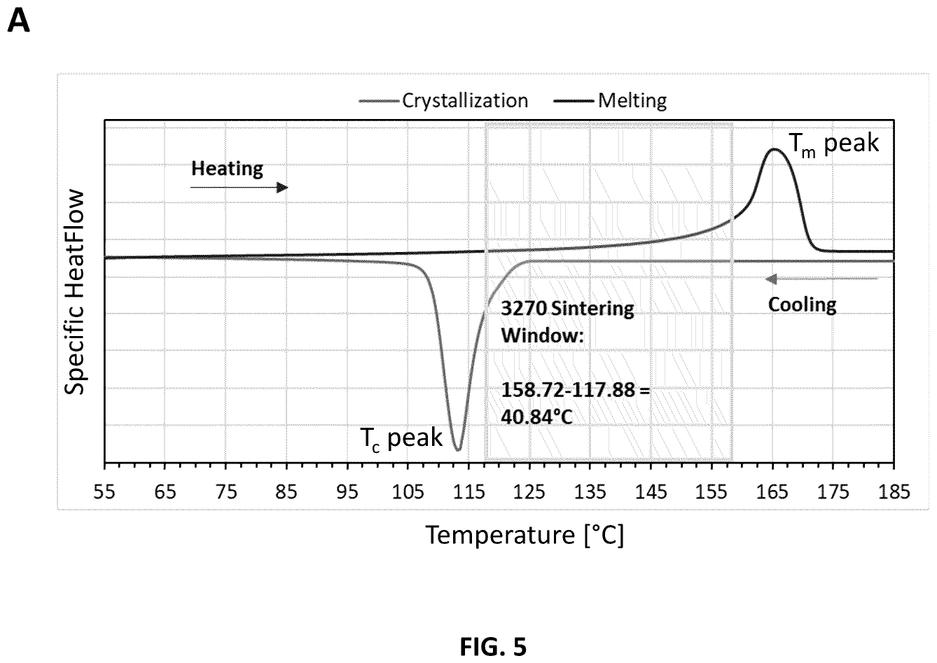

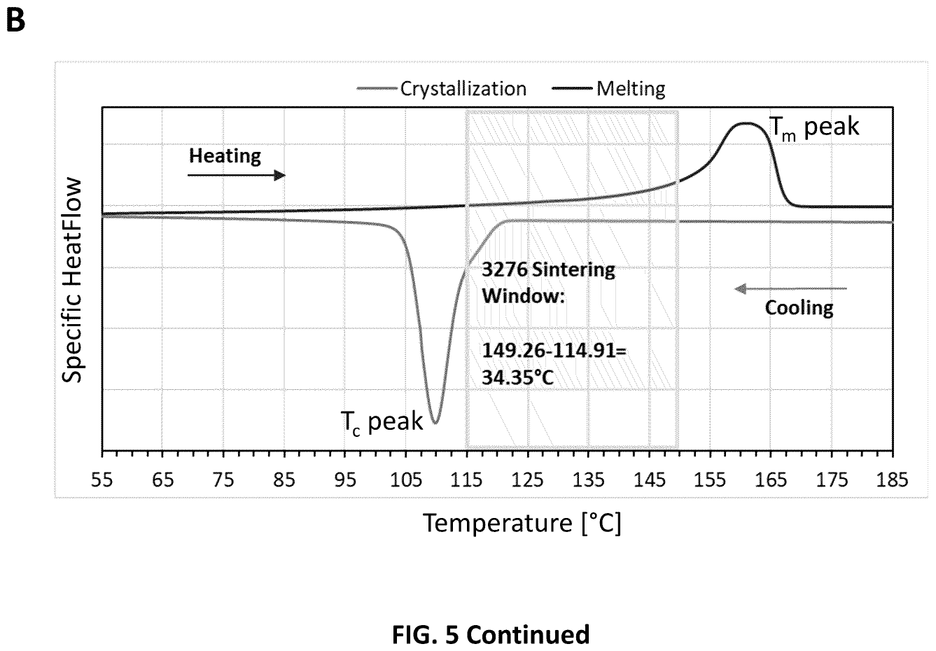

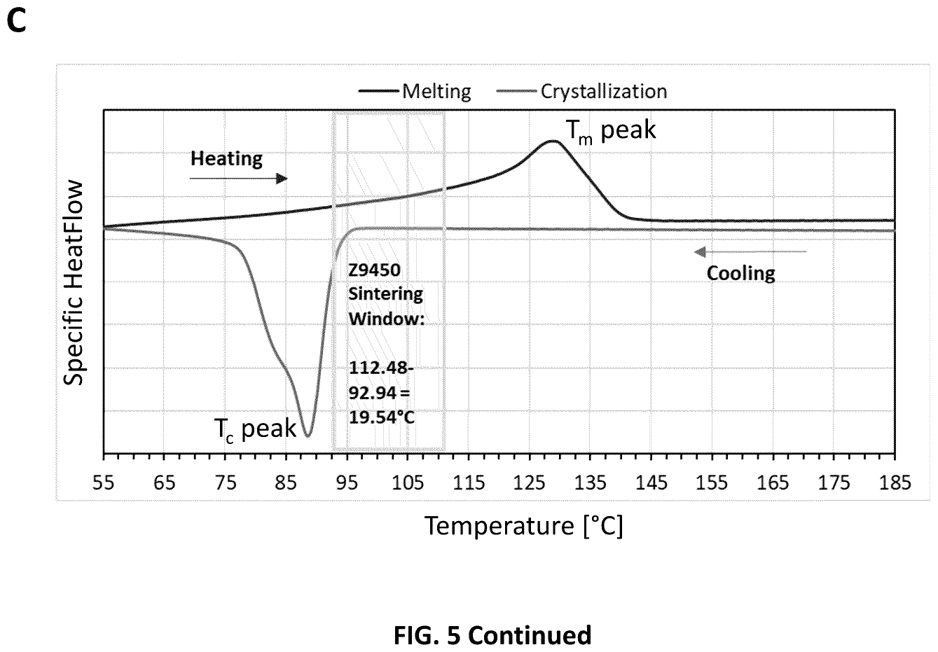

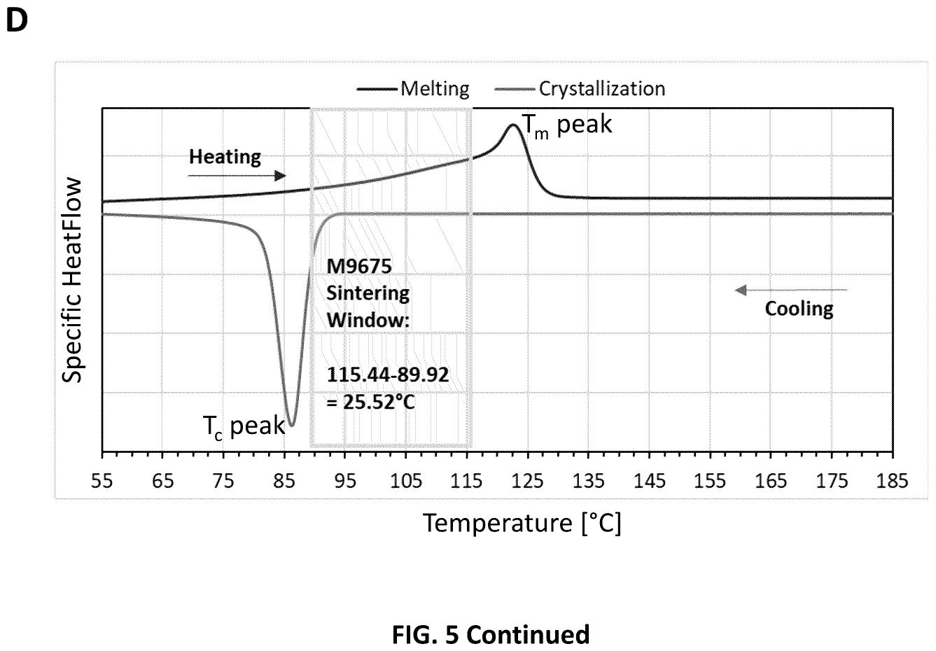

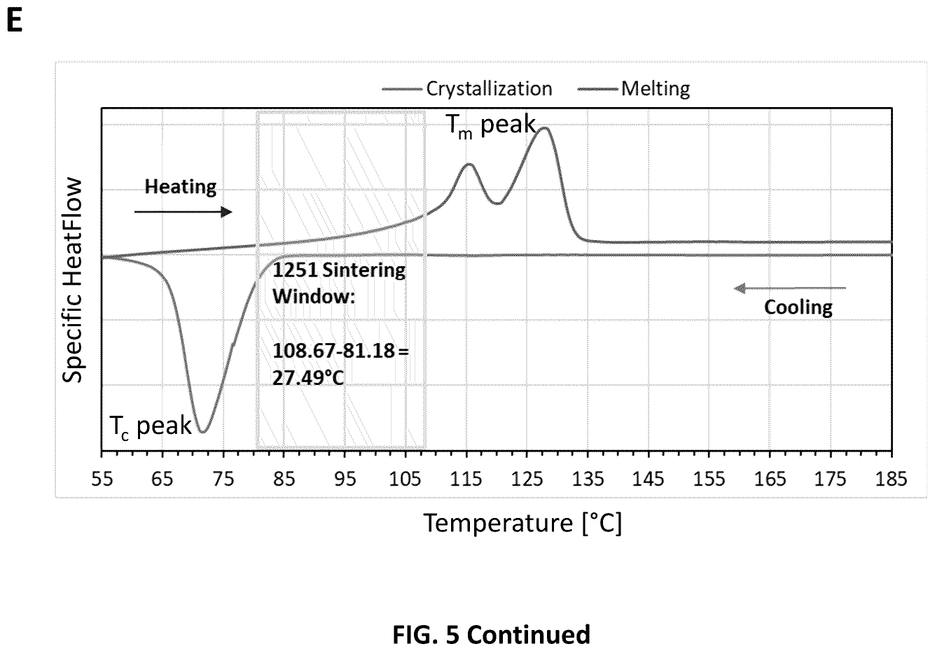

The subtly variations described in Example 2 were further illustrated and characterized through definition of the metastable processing windows calculated as between the onset melting (Tm-onset) and onset crystallization (Tc-onset) temperatures (see FIG. 5 A-E). For expediency, this metastable region will follow the SLS convention and be called the “sintering window”. However, this metastable region has broader utility for AM processes, and is not limited to SLS. For example, in FDM processes, both onset temperatures have practical processing importance.

For Tc-onset, Pogodina and Winter discuss polypropylene crystallization as a physical gelation process, where gelation occurs at 2% crystallinity or less (see e.g., Natalia V. Pogodina and H. Henning Winter, Polypropylene Crystallization as a Physical Gelation Process. Macromolecules, 1998). This gelation process is a transformation point where bulk flow of the melt stops. The incipient crystallites serve as physical crosslinks, causing viscosity to dramatically rise. This physical change means any further layer-layer bonding will be governed by intermolecular diffusion (reptation) of polymer chains at the boundary and its competition with further crystallization where polymer chains fold into crystallites. To the degree that any physical mechanism, such as crystallization, arrests further interboundary chain diffusion, it may produce a less strong layer-layer bond (see e.g., Rhugdhrivya Rane. Enhancing tensile Strength of FDM parts using Thermal Annealing and Uniaxial Pressure. Master of Science in Mechanical Engineering Thesis, December 2018, University of Texas at Arlington).

For Tm-onset, as each layer is deposited, it must melt some portion of the adjacent layer to enable bonding (see e.g., “Fused Deposition Modeling (FDM) 3D Printing—Simply Explained” by pick3dprinter.com). Often the prior layer is in a transition state, with the melt at least at physical gelation or beyond that, where a thin crystalline layer is undergoing primary crystallization over a core layer in a metastable state. The prior layer may need to have sufficient load-bearing capacity to resist flowing with the addition of this new layer. Otherwise the successive deposition of layers may induce creeping flow and yield a heavily distorted part. Given this, at the layer-layer interface, the temperature should exceed the Tm-onset temperature. The fresh molten extrudate should reach at least that temperature to have molten species on both sides of the layer-layer interface. Labile chains can then undergo molecular diffusion across the interface to create bond strength. In this context, the Tm-onset can be viewed, in some instances, as a minimum boundary in FDM processing.

Assessment of the sintering window (see FIGS. 5 A-E) provided a new perspective between the immediate characterization of the resins versus the prior evaluations that generally consider just melting and crystallization temperatures. The immediate approach provided a view of incipient phase transitions and how that physics can govern aspects germane to AM processing and properties.

Polypropylene 3270 exemplified a more crystalline polypropylene homopolymer (see FIG. 5 A). The melting and crystallization peaks were stronger and tended to be more leptokurtic than the other polymers studied, meaning that the peak melting and crystallization temperatures were closer to the onset temperatures. This coupled with the melt supercooling well below the melting temperature, resulted in a wide sintering window. The representative DSC traces in FIG. 5 A yield a >40° C. sintering window. Polypropylene 3276 represented a less crystalline polypropylene homopolymer (see FIG. 5 B). The peaks were not quite as sharp as with 3270, particularly the melting peak. The broader melting peak in particular pushed the Tm-onset to a lower temperature and narrowed the sintering window when compared to 3270.

For random copolymers (Z9450 and M9675), the melting peak behavior exaggerated the trend observed when comparing 3276 to 3270. The melting peaks were more platykurtic when compared to either 3276 or 3270 (see FIGS. 5 C and D). In particular, the melting peak for Z9450 had a very broad character to it that pushed the Tm-onset temperature down to 112.48° C. The representative DSC traces of Z9450 and M9675 produced narrower sintering windows of 19.54° C. and 25.52° C., respectively.

The behavior of syndiotactic polypropylene (1251) merited its own overview. As a homopolymer, it had a much narrower sintering window of 27.49° C. versus those of 3270 and 3276 (see FIG. 5 E). This narrowness was likely due to its bimodal melting endotherm, as a smaller peak appears before the major peak, it pushed the Tm-onset down to 108.67° C. Also important was the shape of the crystallization peak. It was much broader than the other homopolymers, meaning initial crystallites formed just below 85° C.

The aforementioned qualitative descriptions are quantified in Table 8. Related observations are outlined below.

3270 and M9675 had the lowest difference between peak melting temperature and onset of melting. This result was consistent with molecular architecture. 3270, as a high crystallinity homopolymer, has high stereoregularity. M9675, as a metallocene random copolymer, has high regularity in ethylene insertions. In both cases, the consistency in molecular architecture helped drive fast crystallization kinetics. Once incipient crystallites formed, they quickly caused broad self-nucleation within the melt.

Z9450 and 1251 had the largest difference between peak melting temperature and onset of melting. This result was also consistent with molecular architecture. Z9450, as a high ethylene Ziegler-Natta random copolymer, had much less consistency in ethylene insertion (e.g., the ethylene insertion creates blocks of multiple ethylene units rather than an even dispersion where ethylene-ethylene linkages are rare). 1251, as syndiotactic polypropylene, had less consistency in syndiotactic stereoblocks than found in isotactic polypropylene. This molecular architecture favored a broader continuum of crystals with varying degrees of imperfection, leading to a broader melting endotherm overall.

1251 was distinct in its crystallization, having the broadest difference between onset of crystallization and peak crystallization temperature. For 1251 the difference was 9.56° C., while for the other four polypropylenes, the difference covered a range of 3.73 to 5.01° C.

Schmid et al., stated that one should strive for a sintering window that is as broad as possible. But as is observed herein, for polypropylene, such a unilateral statement would not be accurate. In some instances, compromises exist which favor random copolymers and sPP over homopolymer polypropylene. Such compromises are outlined below.

Slower crystallization kinetics (larger Tc onset-Tc) was preferable in some instances. A melt that crystallized more slowly allowed more time for stress relaxation and more time for polymer chains to diffuse across the layer-layer boundary. This factor particularly favored syndiotactic polypropylene in AM, despite having a narrower sintering window than conventional Zielger-Natta homopolymer polypropylenes like 3270 and 3276.

Lower Tc onset was preferable in some instances. A lower crystallization onset temperature provided more time for molten extrudate to cool before crystallization started, helping relax stresses and maximize layer-layer polymer diffusion. This factor particularly favored random copolymers and syndiotactic polypropylene in AM over conventional Zielger-Natta homopolymer polypropylenes like 3270 and 3276.

Broader Tm-Tm onset was preferable in some instances. The balance between extrudate temperature in FDM and layer temperature can be delicate. If the extrudate temperature is too hot, it can melt the prior layer and damage part geometry. A broader melting endotherm was particularly desirable to avoid this problem. Pogodina and Winter's physical gelation concept works in reverse too—residual higher melting crystalline species can serve as physical crosslinks and resist flow. Syndiotactic PP and Z9450 were advantaged in this respect when compared to conventional homopolymer polypropylenes like 3270 and 3276.

Lower crystallinity was preferable in some instances. For FDM, the tendency is for the technology to prefer amorphous polymers versus semi-crystalline polymers as they tend towards less shrinkage, less warpage and less distortion (see e.g., Abishek Kafle, et al., 3D/4D Printing of Polymers: Fused Deposition Modelling (FDM), Selective Laser Sintering (SLS), and Stereolithography (SLA). Polymers. Sep. 15, 2021). Viewed as a continuum, that means a less crystalline polypropylene should tend towards less shrinkage, less warpage and less distortion. The lower melting random copolymers (e.g., M9675 and Z9450) and syndiotactic polypropylene (e.g., 1271) fit that description (see Table 8). These polypropylenes were less crystalline than conventional homopolymer polypropylenes like 3270 and 3276.

TABLE 8
Onset temperatures, melting temperatures and crystallization temperatures.

| | | | | | | | | Tc |
|---|---|---|---|---|---|---|---|---|
| | | Tm | Tc | (Tm − Tc) | | Tm − Tm | | onset − |
| | PP | onset | onset | onset | Tm | onset | Tc | Tc |
| Grade | Type | (° C.) | (° C.) | (° C.) | (° C.) | (° C.) | (° C.) | (° C.) |
| 3270 | IZNHCH | 158.72 | 117.88 | 40.84 | 165.21 | 6.49 | 113.15 | 4.73 |
| 3276 | IZNH | 149.26 | 114.91 | 34.35 | 160.90 | 11.64 | 109.90 | 5.01 |
| Z9450 | ZNRC | 112.48 | 92.94 | 19.54 | 128.77 | 16.29 | 88.63 | 4.31 |
| M9675 | MRC | 115.44 | 89.92 | 25.52 | 122.61 | 7.17 | 86.19 | 3.73 |
| 1251 | SMH | 108.67 | 81.18 | 27.49 | 127.76 | 19.09 | 71.62 | 9.56 |

Melting temperature = Tm;
Crystallization temperature = Tc;
Isotactic Ziegler-Natta high crystallinity homopolymer = IZNHCH;
Isotactic Ziegler-Natta homopolymer = IZNH;
Ziegler-Natta random copolymer = ZNRC;
Metallocene random copolymer = MRC;
Syndiotactic metallocene homopolymer = SMH

### D. Example 4—Isothermal Crystallization and Avrami Kinetics

The idea that the various polypropylenes could have different crystallization kinetics was studied through isothermal DSC testing. Historically the Avrami equation has been used for this purpose (see e.g., Catherine A. Kelly and Mike J. Jenkins, Modeling the crystallization kinetics of polymers displaying high levels of secondary crystallization. Polymer Journal, Nov. 19, 2021; TA393 Comparison of Crystallization Behavior of Different Colored Parts Made from Polypropylene Using a Single DSC Experiment, TA Instruments; and TA222 by J. A. Foreman and R. L. Blaine, Isothermal Crystallization Made Easy: A Simple Model and Modest Cooling Rates, TA Instruments.)

$$The Avrami Equation .$$

$${X}_{t} = ( 1 - {e}^{- {k}_{a} {t}^{{n}_{a}}} ) . \qquad Equation 1$$

The parameters of the Avrami equation can be determined from the gradient (nₐ) and antilogarithm of the y-intercept (kₐ) of a double log plot of log(−ln(1−Xₜ)) versus log time. The Avrami Equation (Equation 1) can be rearranged for this purpose as shown in the Linear form of the Avrami equation (Equation 2). The Avrami equation parameters are defined as follows: Xₜ=Fractional crystallinity at time t; Kₐ=Avrami rate constant; nₐ=Avrami exponent, which in theory should be an integer between one and four. It represents the mechanism of nucleation on geometry of growth.

$$Linear form of the Avrami equation with a simplified interpretation ( see e . g . , TA393 Comparison of Crystallization Behavior of Different Colored Parts Made from Polypropylene Using a Single DSC Experiment , TA Instruments )$$

$$log ( - ln ( 1 - X ( t ) ) = log {k}_{a} + {n}_{a} log t . \qquad Equation 2$$

A plot of the log(−ln(1−Xₜ)) versus log t is linear and yields the Avrami parameters Ka (antilog of intercept) and na (slope). The Avrami exponent correlates with the nucleation growth geometry and is summarized as follows (simplified Avrami exponent interpretation): Avrami Exponent 1≤n≤2 results in growth geometry of 1-dimensional, rod-like; Avrami Exponent 2≤n≤3 results in growth geometry of 2-dimensional, disc-like; and Avrami Exponent 3≤n≤4 results in growth geometry of 3-dimensional, spherulitic.

The rate constant usually follows an Arrhenius relationship with temperature (see e.g., Luljeta Raka and Gordana Bogoeva-Gaceva, Crystallization of polypropylene: Application of Differential Scanning Colorimetry, Part 1. Isothermal and non-isothermal crystallization, 2008).

$$Arrhenius relationship for Avrami rate constant {K}_{a} .$$

$${k}_{a} = {Ae}^{- [ \frac{{E}_{a}}{R T} ]} \qquad Equation 3$$

The Arrhenius equation parameters are defined as follows: Kₐ=Avrami rate constant; A=Pre-exponential factor; Eₐ=Activation Energy; R=Gas Constant=8.314 J/(mol·K); and T=Temperature (in Kelvin).

$$Linearized version of the Arrhenius relationship for Avrami rate constant {K}_{a} .$$

$$ln {k}_{a} = ln A - \frac{{E}_{a}}{RT} \qquad Equation 4$$

Isothermal DSC scans were performed on the various polypropylenes (3270, 3276, Z9450, M9675, and 1251), with each scan fit to the Avrami equation. The coefficients of determination (r2) to the fits were excellent, with values generally exceeding 0.995.

The isothermal temperatures used in testing each polypropylene were compared against typical crystallization temperatures in nonisothermal DSC testing (see Table 9). The comparisons revealed a good ranking agreement. 3270 had the highest Tc and had the highest isothermal temperature range. On the other end of the spectrum, 1251 had the lowest Tc and had the lowest isothermal temperature range. The consistency of these results, coupled with the r2 values, gave reassurance that the isothermal test data captured nuance in crystallization kinetics.

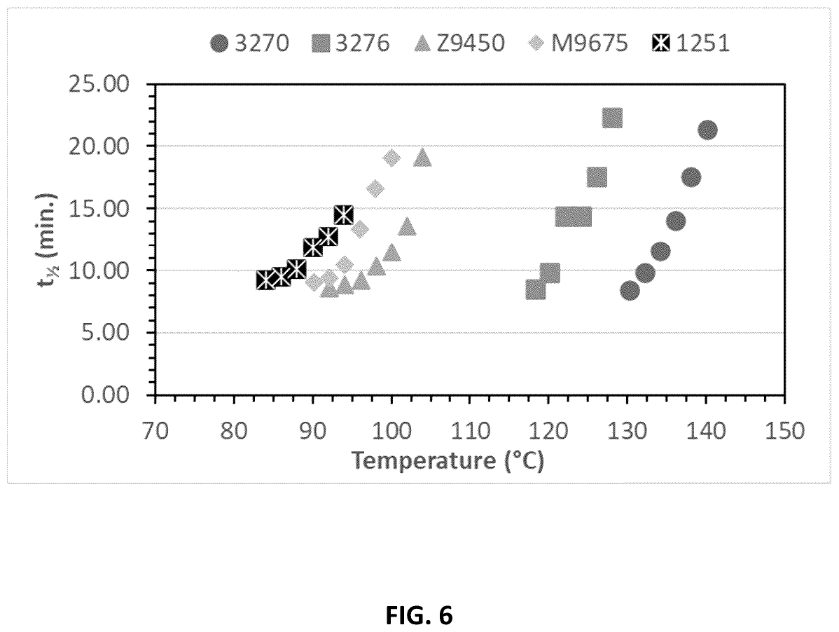

A visual check was made of the data by plotting crystallization half-time (t½) versus temperature (see FIG. 6). The shapes followed expected trends. 3270 and 3276 appeared to have a half-time that is more sensitive to temperature than the random copolymers or syndiotactic polypropylene. Restated, as the isothermal temperature was lowered, 3270 and 3276 crystallized more quickly.

TABLE 9
Typical nonisothermal crystallization temperatures and the
isothermal crystallization temperature range for each PP.

| | | | Isothermal |
|---|---|---|---|
| | | | Temperature |
| Grade | PP Type | Tc (° C.) | Range (° C.) |
| 3270 | IZNHCH | 117.47 | 130-140 |
| 3276 | IZNH | 114.76 | 118-128 |
| Z9450 | ZNRC | 90.57 | 92-104 |
| M9675 | MRC | 82.38 | 90-100 |
| 1251 | SMH | 67.16 | 84-94 |

Melting temperature = Tm;
Crystallization temperature = Tc;
Isotactic Ziegler-Natta high crystallinity homopolymer = IZNHCH;
Isotactic Ziegler-Natta homopolymer = IZNH;
Ziegler-Natta random copolymer = ZNRC;
Metallocene random copolymer = MRC;
Syndiotactic metallocene homopolymer = SMH

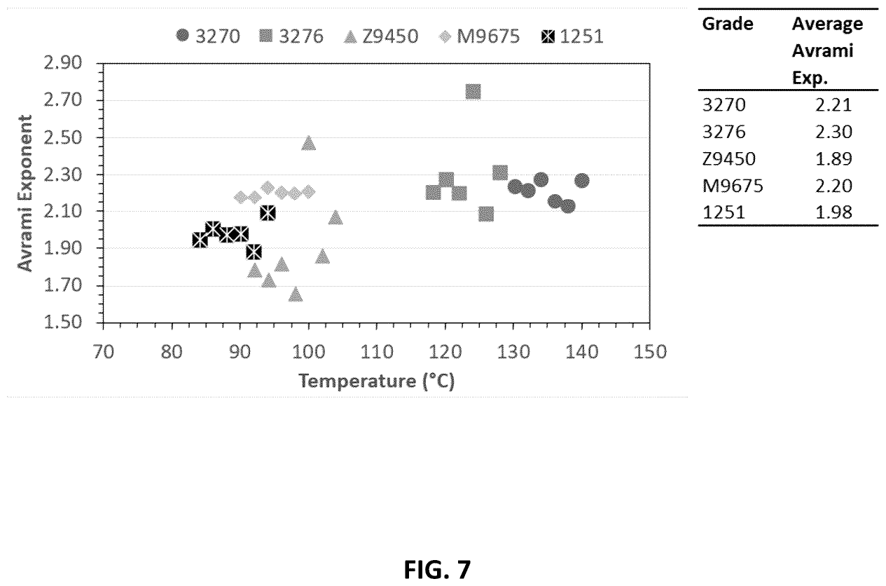

For polypropylene, typical literature Avrami exponents were broadly between 2 and 3 (see e.g., TA393 Comparison of Crystallization Behavior of Different Colored Parts Made from Polypropylene Using a Single DSC Experiment, TA Instruments; TA425 Applying the Avrami and Malkin Macrokinetic Models for Evaluating Isothermal Crystallization Kinetics of Polypropylene with and without a Chemical Nucleator, TA Instruments; and Pitt Supaphol, Application of the Avrami, Tobin, Malkin, and Urbanovici-Segal microkinetic models to isothermal crystallization of syndiotactic polypropylene. Thermochimica Acta, 2001). The results of these fits followed that trend (see FIG. 7). A noticeable result was that Z9450 and 1251 had lower Avrami exponents than the other polymers. This indicated that these crystallization processes deviated most from spherulitic growth; as the melt crystallizes the crystals had stronger directional preference than in 3270, 3276 and Z9450. The broader crystallization exotherms for Z9450 and 1251 could reflect this aspect of their kinetics. To the degree this correlation exists within unnucleated polypropylene, polypropylene with lower Avrami exponents would be preferred for AM in some instances.

Equation 4, the linearized Arrhenius relationship, was utilized to yield slopes that corresponded to activation energies (Ea) when plotted as ln ka versus (1/RT). The activation energies illustrate how sensitive crystallization temperature was to temperature; a higher slope is equivalent to more sensitive and a lower slope less sensitive. From an AM perspective, in some instances, polypropylenes with a lower slope were favored because the crystallization process accelerates more slowly as temperature decreases. Slow kinetics favored more time for polymer chain diffusion between layers and more resilience against processing temperature variation.

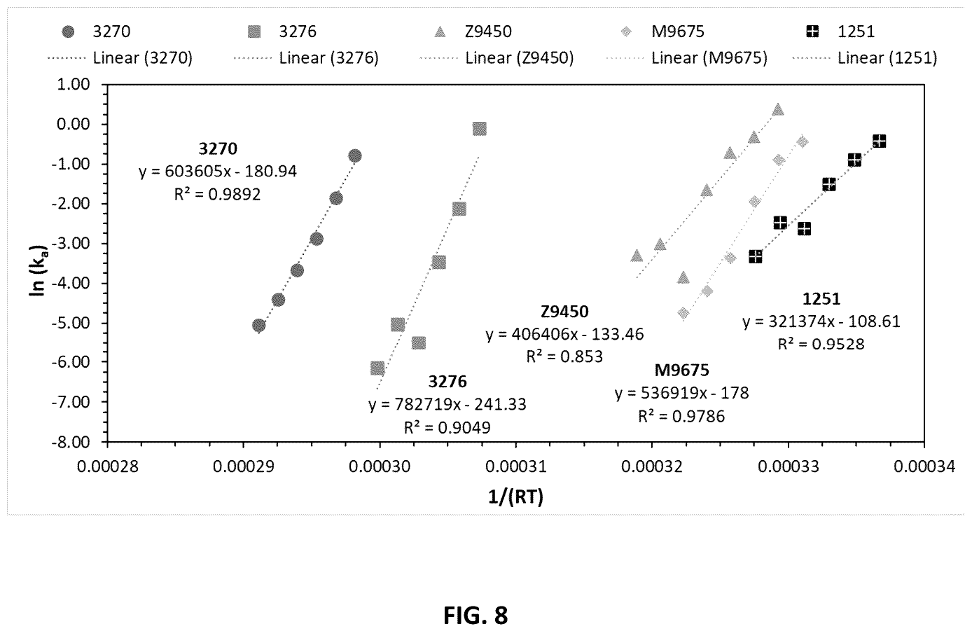

The linearized Arrhenius relationship for each polypropylene is presented in FIG. 8. The linear best fits are included, with the slope=−Eₐ (J/mol). The crystallization activation energies for each PP were calculated, and their relative crystallization activation energies were noted (see Table 10).

TABLE 10
Crystallization activation energies for each polypropylene.

| | | | |
|---|---|---|---|
| | | | Relative crystallization |
| Grade | PP Type | −Eₐ (J/mol) | activation energy |

| | | | | |
|---|---|---|---|---|
| 3270 | IZNHCH | −603,605 | 100% | ~77% |
| 3276 | IZNH | −782,719 | ~130% | 100% |
| Z9450 | ZNRC | −406,406 | ~67% | ~52% |
| M9675 | MRC | −536,919 | ~89% | ~69% |
| 1251 | SMH | −321,374 | ~53% | ~41% |

Activation energies = Ea;
Isotactic Ziegler-Natta high crystallinity homopolymer = IZNHCH;
Isotactic Ziegler-Natta homopolymer = IZNH;
Ziegler-Natta random copolymer = ZNRC;
Metallocene random copolymer = MRC;
Syndiotactic metallocene homopolymer = SMH

These crystallization activation energy results quantified the observations from FIG. 6. There were clear differences between the polypropylenes, with syndiotactic polypropylene having ˜50% lower Eₐ than 3270 and 3276. While Z9450's Eₐ is ˜40% lower and M9675 is ˜22.5% lower than 3270 and 3276 respectively.

The findings described throughout this disclosure teach that polypropylene cannot be viewed monolithically for additive manufacturing (AM). Traditional metrics for some AM, like sintering window, may not provide a complete assessment of useability for AM. A thorough assessment of thermal behavior, using both nonisothermal and isothermal testing, as described herein, can provided a foundation for what polypropylene attributes are preferable in AM.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. An additive manufactured article comprising one or more polypropylene (PP) with one or more of the following properties:
a) a melting temperature≤135° C., measured according to ASTM D3418-15;
b) an onset of melting temperature≤125° C., measured according to ASTM D3418-15;
c) an onset of crystallization temperature≤105° C., measured according to ASTM D3418-15;
d) crystallinity of ≤35%, measured according to ASTM D3418-15;
e) an Avrami exponent≤2.10;
f) an absolute value for crystallization activation energy≤550,000 J/mol, as determined from Avrami kinetics fits; and/or
g) an absolute value for crystallization activation energy that is less than or equal to 80% of the absolute value for crystallization activation energy of an unnucleated Ziegler-Natta homopolymer polypropylene.

2. The additive manufactured article of claim 1, comprising one or more PP with one or more of the following characteristics:
a) a melting temperature≤130° C., measured according to ASTM D3418-15;
b) an onset of melting temperature≤120° C., measured according to ASTM D3418-15;
c) an onset of crystallization temperature≤100° C., measured according to ASTM D3418-15;
d) crystallinity of ≤30%, measured according to ASTM D3418-15;
e) an Avrami exponent≤2.05;
f) an absolute value for crystallization activation energy≤500,000 J/mol, as determined from Avrami kinetics fits; and/or
g) an absolute value for crystallization activation energy that is less than or equal to 75% of the absolute value for crystallization activation energy of an unnucleated Ziegler-Natta homopolymer polypropylene.

3. The additive manufactured article of claim 1, comprising one or more PP with at least two of the following characteristics:
a) a melting temperature≤135° C. or ≤130° C., measured according to ASTM D3418-15;
b) an onset of melting temperature≤125° C. or ≤120° C., measured according to ASTM D3418-15;
c) an onset of crystallization temperature≤105° C. or ≤100° C., measured according to ASTM D3418-15; and/or
d) crystallinity of ≤35% or <30%, measured according to ASTM D3418-15.

4. The additive manufactured article of claim 1, wherein the at least one polypropylene is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.

5. The additive manufactured article of claim 1, wherein the PP has an absolute value for crystallization activation energy, as determined by isothermal differential scanning calorimetry (DSC) testing according to ASTM D3418-15 combined with Avrami kinetics fits, that are between about 300,000 J/mol to about 500,000 J/mol.

6. The additive manufactured article of claim 1, wherein the PP has a crystallinity of 35% to 15% based on a theoretical heat of fusion (ΔH₀ₘ) for 100% crystallized polypropylene of 207 J/g.

7. The additive manufactured article of claim 1, wherein the PP has a sintering window of 30° C. or lower, as defined by onset melting and crystallization temperatures.

8. The additive manufactured article of claim 7, wherein the PP has a sintering window of 18° C. to 30° C.

9. The additive manufactured article of claim 1, wherein the PP has a density of 0.8 g/cc to 1 g/cc measured according to ASTM D1505-18, and/or melt flow rate (MFR) of 0.1 g/10 min to 100.0 g/10 min, measured according to ASTM D1238-20.

10. The additive manufactured article of claim 1, wherein the PP has a melt flow of 0.5 g/10 min to 30 g/min, measured according to ASTM D1238-20.

11. A method of making the additive manufactured article of claim 1, the method comprising melting and/or sintering a composition comprising the one or more PP.

12. The method of claim 11, wherein the at least one polypropylene is a Ziegler-Natta based random copolymer, metallocene random copolymer, and/or syndiotactic polypropylene, and optionally, further comprises at least one additive, wherein the additive comprises silica, an antistatic agent, a pigment, an anticorrosion agent, an antioxidant, an acid neutralizer, an antiblock agent, an antifog agent, a clarifying agent, an ultraviolet absorber, a lubricant, a plasticizer, a mineral oil, a wax, a clay, talc, calcium carbonate, diatomaceous earth, carbon black, mica, glass fibers, a filler, a slip agent, a pigment, an ultraviolet stabilizer and/or resistance agent, a fire retardant, a mold release agent, a dye, a blowing agent, a fluorescent agent, a surfactant, an oil, a neutralizing agent, a flow modifier, a processing agent, a reinforcing agent, a stabilizer, an impact modifier, a nucleating agent, a crystallization aid, another polymer, or any combinations thereof.

13. The method of claim 11, wherein the article is made by sintering the PP in particulate form having an average particle size of 1 μm to 500 μm.

14. The method of claim 13, wherein the particulate has an average particle size of 15 μm to 100 μm.

15. The method of claim 11, wherein the method comprises material extrusion, wherein the composition in a melted state is extruded through a nozzle and is deposited in layers.

16. The method of claim 11, wherein the method comprises sintering particles of the composition in a particulate form in a powder bed sintering (PBS) process.

17. The method of claim 16, wherein the PBS process uses a layer thickness of 10 μm to 200 μm and/or a part bed temperature of 20° C. to 100° C.

18. The method of claim 17, wherein the PBS process uses a layer thickness of 30 μm to 150 μm.

19. An article of manufacture comprising the additive manufactured article of claim 1, wherein the article is an automobile part, building material part, insulation part, electric instrument part, furniture part, textile part, container part, home appliance part, medical part, prosthetic, filter media, and/or custom toy.

20. A composition for additive manufacturing, wherein the composition comprises at least one polypropylene (PP), and is in contact with at least one component designed for use in a 3-D printer, wherein the PP comprises one or more of the following properties:
a) a melting temperature≤135° C., measured according to ASTM D3418-15;
b) an onset of melting temperature≤125° C., measured according to ASTM D3418-15;
c) an onset of crystallization temperature≤105° C., measured according to ASTM D3418-15;
d) crystallinity of ≤35%, measured according to ASTM D3418-15;
e) an Avrami exponent≤2.10;
f) an absolute value for crystallization activation energy≤550,000 J/mol, as determined from Avrami kinetics fits; and/or
g) an absolute value for crystallization activation energy that is less than or equal to 80% of the absolute value for crystallization activation energy of an unnucleated Ziegler-Natta homopolymer polypropylene.

21. The composition of claim 19, comprising one or more polypropylene (PP) with one or more of the following characteristics:
a) a melting temperature≤130° C., measured according to ASTM D3418-15;
b) an onset of melting temperature≤120° C., measured according to ASTM D3418-15;
c) an onset of crystallization temperature≤100° C., measured according to ASTM D3418-15;
g) crystallinity of <30%, measured according to ASTM D3418-15;
d) an Avrami exponent≤2.05;
e) an absolute value for crystallization activation energy≤500,000 J/mol, as determined from Avrami kinetics fits; and/or
f) an absolute value for crystallization activation energy that is less than or equal to 75% of the absolute value for crystallization activation energy of an unnucleated Ziegler-Natta homopolymer polypropylene.

22. The composition of claim 20, comprising one or more PP with at least two of the following characteristics:
a) a melting temperature≤135° C. or ≤130° C., measured according to ASTM D3418-15;
b) an onset of melting temperature≤125° C. or ≤120° C., measured according to ASTM D3418-15;
c) an onset of crystallization temperature≤105° C. or ≤100° C., measured according to ASTM D3418-15; and/or
d) crystallinity of ≤35% or ≤30%, measured according to ASTM D3418-15.

23. The composition claim 20, wherein the PP is in contact with a 0.4 mm extruder nozzle, a 0.35 mm extruder nozzle, a build plate, and/or a heated bed.
